(19) United States
(12) Patent Application Publication
(10) Pub. No.: US 2026/0236213 A1
(43) Pub. Date: Aug. 13, 2026

(54) DISPLAY APPARATUS AND MULTI-CHANNEL CASTING CONTROL METHOD

(71) Applicant: HISENSE VISUAL TECHNOLOGY CO., LTD., Shandong (CN)

(72) Inventors: Na ZHANG, Shandong (CN); Xiaoyan MA, Shandong (CN); Jinkun LI, Shandong (CN); Ziquan SONG, Shandong (CN); Xuesheng ZHU, Shandong (CN); Xiujuan PANG, Shandong (CN); Chengchuang XIAO, Shandong (CN); Guanghai ZHUANG, Shandong (CN); Meiyu LIU, Shandong (CN); Jingkun ZHANG, Shandong (CN)

(21) Appl. No.: 19/633,156

(22) Filed: Mar. 30, 2026

Related U.S. Application Data
(63) Continuation of application No. PCT/CN2024/121088, filed on Sep. 25, 2024.

(30) Foreign Application Priority Data
Nov. 16, 2023 (CN) 202311529991.8
Nov. 16, 2023 (CN) 202311530008.4
Nov. 16, 2023 (CN) 202311530019.2
Nov. 16, 2023 (CN) 202311533170.1
Nov. 16, 2023 (CN) 202311533185.8

(51) Int. Cl. G06F 3/14; G06F 3/16; H04N 21/431; H04N 21/462; H04N 21/485

(52) U.S. Cl. CPC G06F 3/1454; H04N 21/4316; H04N 21/4622; H04N 21/4858; G06F 3/162

(57) ABSTRACT

The present disclosure provides a display apparatus and a multi-channel casting control method. The method includes: in response to a casting connection command sent from a first terminal device, creating a first casting window and releasing a first guide window; acquiring a first casting session sent from the first terminal device, and detecting a screen resolution and a reference resolution of a guide page; and calculating a first display area and a second display area based on the screen resolution, a first resolution, and the reference resolution, and displaying the first casting window in the first display area, and displaying a second guide window in the second display area. The height of the first display area is equal to that of the second display area.

### CROSS REFERENCE TO RELATED APPLICATIONS

This application is a continuation of International Application No. PCT/CN 2024/121088, filed on Sep. 25, 2024, which claims priorities to the Chinese patent application No. 202311529991.8 filed on Nov. 16, 2023, the Chinese patent application No. 202311533170.1 filed on Nov. 16, 2023, the Chinese patent application No. 202311530019.2 filed on Nov. 16, 2023, the Chinese patent application No. 202311530008.4 filed on Nov. 16, 2023 and the Chinese patent application No. 202311533185.8 filed on Nov. 16, 2023, all of which are hereby incorporated by reference in their entireties.

### FIELD

The present application relates to the field of a display apparatus, and in particular to a display apparatus and a multi-channel casting control method.

### BACKGROUND

A display apparatus is an intelligent device capable of presenting a user interface and supporting user interaction. The display apparatus can establish a communication connection with terminal devices such as mobile phones, obtain casting screen data from the terminal devices based on a specific casting protocol, and then display casting screens of the terminal devices according to the casting screen data.

Some display apparatuses can establish communication connections with multiple terminal devices at the same time and receive casting screen data from these terminal devices, thereby forming a multi-channel casting scenario. However, in the multi-channel casting scenario, the display apparatus can only display the casting window of a single terminal device. If casting windows for multiple terminal devices are created simultaneously, due to the inability of direct communication between various casting windows, the problem of mutual occlusion of casting windows will occur on the display apparatus.

### SUMMARY

In a first aspect, the embodiments of the present disclosure provide a display apparatus, which may include: a display, configured to display a multi-channel casting interface; where the multi-channel casting interface may include a first guide window and a second guide window; the first guide window and the second guide window each is configured to display a guide page; and the first guide window and the second guide window both share a same root node as the multi-channel casting interface; a user input interface, configured to receive a command from a user; a communication device, configured to establish a communication connection with a terminal device; a memory, configured to store computer instructions and data associated with the display apparatus; and at least one processor, connected to the display, the user input interface, the communication device and the memory; where the at least one processor is configured to execute the computer instructions to enable the display apparatus to: in response to a casting connection command sent from a first terminal device, create a first casting window, release the first guide window, and retain displaying the second guide window in the multi-channel casting interface; where the first casting window is configured to display a first casting screen of the first terminal device, and the first casting window shares the same root node as the multi-channel casting interface; obtain a first casting session sent from the first terminal device, where the first casting session includes a first resolution of the first casting screen; detect a screen resolution and a reference resolution of the guide page; calculate a window display area according to the screen resolution, the first resolution, and the reference resolution; where the window display area includes a first display area and a second display area; and a height of the first display area and a height of the second display area are equal; and control the display to display the first casting window in the first display area and display the second guide window in the second display area.

In a second aspect, the embodiments of the present disclosure provide a multi-channel casting control method, which may include: in response to the casting connection command sent from the first terminal device, creating the first casting window, releasing the first guide window, and retaining displaying the second guide window in the multi-channel casting interface; where the first casting window is configured to display the first casting screen of the first terminal device, and the first casting window shares the same root node as the multi-channel casting interface; the multi-channel casting interface includes the first guide window and the second guide window, and the first guide window and the second guide window each is configured to display the guide page; the first guide window and the second guide window both share the same root node as the multi-channel casting interface; obtaining the first casting session sent from the first terminal device; where the first casting session includes the first resolution of the first casting screen; detecting the screen resolution and the reference resolution of the guide page; calculating the window display area according to the screen resolution, the first resolution, and the reference resolution; where the window display area includes the first display area and the second display area, and the height of the first display area and the height of the second display area are equal; controlling the display to display the first casting window in the first display area and display the second guide window in the second display area.

### BRIEF DESCRIPTION OF THE DRAWINGS

FIG. 1 is a schematic diagram of a usage scenario of a display apparatus according to some embodiments.

FIG. 2 is a hardware configuration block diagram of a display apparatus according to some embodiments.

FIG. 3 is a hardware configuration block diagram of a control device according to some embodiments.

FIG. 4 is a software configuration block diagram of a display apparatus according to some embodiments.

FIG. 5 is a schematic diagram of screen mirroring according to some embodiments.

FIG. 6 is a schematic diagram of push casting according to some embodiments.

FIG. 7 is a schematic diagram of a multi-channel casting interface according to some embodiments.

FIG. 8 is a schematic diagram of functional modules of a display apparatus according to some embodiments.

FIG. 9 is a schematic diagram of a guide page according to some embodiments.

FIG. 10 is a schematic diagram of a multi-channel casting control process executed by a display apparatus according to some embodiments.

FIG. 11 is a schematic diagram of a display effect of a multi-channel casting interface during single-channel screen casting according to some embodiments.

FIG. 12 is a schematic diagram of a process for displaying a second casting window according to some embodiments.

FIG. 13 is a schematic diagram of a display effect of a multi-channel casting interface during dual-channel screen casting according to some embodiments.

FIG. 14 is another schematic diagram of a display effect of a multi-channel casting interface during dual-channel screen casting according to some embodiments.

FIG. 15 is a schematic diagram of a display effect of floating playback function controls according to some embodiments.

FIG. 16 is a schematic diagram of a display effect of playback function controls displayed in an edge area according to some embodiments.

FIG. 17 is a schematic diagram of a display effect after compressing a casting window according to some embodiments.

FIG. 18 is another schematic diagram of a multi-channel casting control process executed by a display apparatus according to some embodiments.

FIG. 19 is a schematic diagram of a process for setting a replacement mode parameter according to some embodiments.

FIG. 20 is a schematic diagram of a display effect of a lock control according to some embodiments.

FIG. 21 is a schematic diagram of a display effect of a lock control in an unlocked state according to some embodiments.

FIG. 22 is a schematic diagram of a display effect of a third casting window replacing a second casting window according to some embodiments.

FIG. 23 is a schematic diagram of an interface display effect in a second mode according to some embodiments.

FIG. 24 is a schematic diagram of a display effect of a third casting window replacing a first casting window according to some embodiments.

FIG. 25 is another schematic diagram of a display effect of a multi-channel casting interface during single-channel screen casting according to some embodiments.

FIG. 26 is another schematic diagram of a multi-channel casting control process executed by a display apparatus according to some embodiments.

FIG. 27 is a schematic diagram of an effect of six button controls according to some embodiments.

FIG. 28 is a schematic diagram of an effect of dynamically adjusting the number of button controls according to some embodiments.

FIG. 29 is a schematic diagram of an effect of three button controls according to some embodiments.

FIG. 30 is a schematic diagram of an effect of two button controls according to some embodiments.

FIG. 31 is a schematic diagram of an effect of one button control according to some embodiments.

FIG. 32 is a schematic diagram of a full-screen switching effect of a display apparatus according to some embodiments.

FIG. 33 is another schematic diagram of a multi-channel casting control process executed by a display apparatus according to some embodiments.

FIG. 34 is a schematic diagram of a full-screen display effect according to some embodiments.

FIG. 35 is a flow diagram of audio playback control of a display apparatus according to some embodiments.

FIG. 36 is a schematic diagram of a display effect of an audio view according to some embodiments.

FIG. 37 is a schematic diagram of an effect of dynamically adjusting an audio view according to some embodiments.

FIG. 38 is a schematic diagram of a display effect when one screen casting channel is disconnected according to some embodiments.

FIG. 39 is a flow diagram of audio switching when screen casting is disconnected according to some embodiments.

FIG. 40 is a schematic diagram of an effect of audio mode locking of a casting window according to some embodiments.

FIG. 41 is another schematic diagram of a full-screen switching effect of a display apparatus according to some embodiments.

### DETAILED DESCRIPTION OF THE EMBODIMENTS

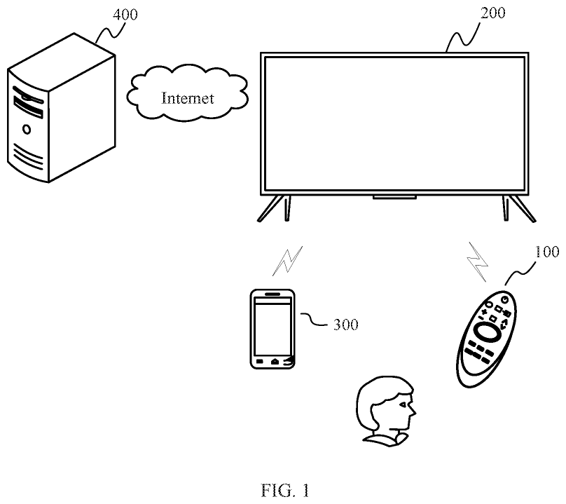

FIG. 1 is a schematic diagram of an operation scenario between a display apparatus and a control device according to some embodiments. As shown in FIG. 1, a user can operate the display apparatus 200 through a touch operation, a mobile terminal 300, and a control device 100. The control device 100 may be a remote control, a stylus pen, or the like.

In some embodiments, the mobile terminal 300 and the display apparatus 200 can have software applications installed, and realize connection and communication through network communication protocols to achieve the purpose of one-to-one control operation and data communication. It is also possible to transmit the audio and video content displayed on the mobile terminal 300 to the display apparatus 200 to realize a synchronous display function.

Continuing to refer to FIG. 1, the display apparatus 200 can also perform data communication with a server 400 through various communication methods. For example, the display apparatus 200 may be allowed to establish communication connections through a local area network (LAN), a wireless local area network (WLAN), and other networks.

In addition to providing a broadcast receiving television (TV) function, the display apparatus 200 can additionally provide an intelligent network TV function with a computer-supported function, including but not limited to a network TV, a smart TV, an Internet Protocol TV (IPTV), and the like.

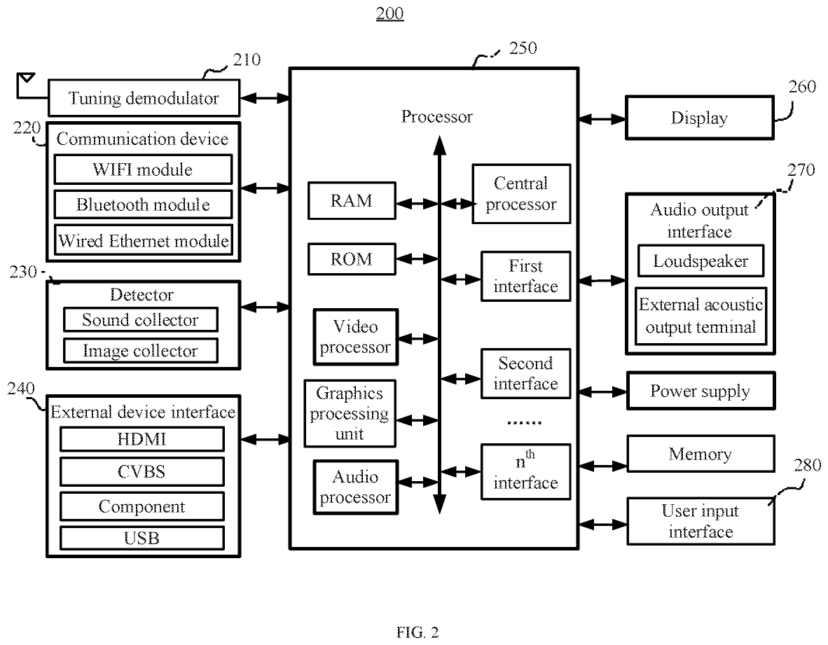

FIG. 2 is a hardware configuration block diagram of the display apparatus 200 shown in FIG. 1. As shown in FIG. 2, the display apparatus 200 may include at least one of a tuning demodulator 210, a communication device 220, a detector 230, an external device interface 240, one or more processors 250, a display 260, an audio output interface 270, a memory, a power supply, and a user input interface.

In some embodiments, the detector 230 may be configured to collect signals from the external environment or signals interacting with the outside. For example, the detector 230 includes a light receiver, which is a sensor for collecting the intensity of ambient light. Or, the detector 230 includes an image collector, such as a camera, which can be configured to collect external environment scenes, user attributes, or user interaction gestures. Or, the detector 230 includes a sound collector, such as a microphone, for receiving external sounds.

In some embodiments, the display 260 may include: a display screen assembly for presenting images; a driving component for driving image display; and a component for receiving image signals, and displaying video content, image content, menu control interfaces and user control UI interfaces, etc.

In some embodiments, the communication device 220 is a component for communicating with external devices or the server 400 according to various communication protocol types. The display apparatus 200 may be provided with a plurality of communication devices 220 according to different supported communication modes. For example, when the display apparatus 200 supports wireless network communication, the display apparatus 200 may be provided with a communication device 220 including a WiFi function. When the display apparatus 200 supports Bluetooth connection communication, the display apparatus 200 needs to be provided with a communication device 220 including a Bluetooth function.

The communication device 220 can enable the display apparatus 200 to establish a communication connection with an external device or the server 400 through a wireless or wired connection. The wired connection can connect the display apparatus 200 with an external device through components such as a data cable and an interface. The wireless connection can connect the display apparatus 200 with an external device through a wireless signal or a wireless network. The display apparatus 200 can directly establish a connection with an external device, or indirectly establish a connection through a gateway, a router, a connection device, etc.

In some embodiments, the display apparatus 200 can also support establishing communication connections with multiple external devices at the same time. Multiple external devices can connect to the display apparatus 200 through the same connection method. For example, the external devices are terminal devices 500 such as mobile phones and tablet computers. The first terminal device 510 and the second terminal device 520 can establish a communication connection with the display apparatus 200 by accessing the wireless local area network where the display apparatus 200 is located. Multiple external devices can also connect to the display apparatus 200 through different types of connection methods. For example, the first terminal device 510 is connected to the display apparatus 200 through a wireless local area network, and the second terminal device 520 is connected to the display apparatus 200 through Bluetooth.

To realize the communication connection between the display apparatus 200 and the terminal device 500, the display apparatus 200 and the terminal device 500 are respectively provided with communication devices supporting the same communication type. For example, when the display apparatus 200 is provided with a communication device 220 including a WiFi module, the terminal device 500 should also be provided with a communication device including a WiFi module. In addition to being provided with communication devices of the same type, a specific communication transmission protocol is also required between the display apparatus 200 and the terminal device 500 for data transmission, such as a WiFi protocol, a Bluetooth connection protocol, a ZigBee protocol, a Near Field Communication Protocol (NFC) protocol, etc.

In some embodiments, one or more processors 250 may include a video processor, an audio processor, a graphics processor, a Random Access Memory (RAM), a Read-Only Memory (ROM), and first to nth interfaces for input/output. The one or more processors 250 can control the work of the display apparatus and respond to user operations through various software control programs stored in the memory. The one or more processors 250 can control the overall operation of the display apparatus 200.

In some embodiments, the one or more processors 250 and the tuning demodulator 210 may be located in different separate devices, that is, the tuning demodulator 210 may also be in an external device of a main device where the one or more processors 250 are located, such as an external set-top box.

In some embodiments, the user can input a user command on a Graphical User Interface (GUI) displayed on the display 260, and then the user input interface receives the user input command through the GUI.

In some embodiments, the user input interface 280 may be an interface for receiving control input.

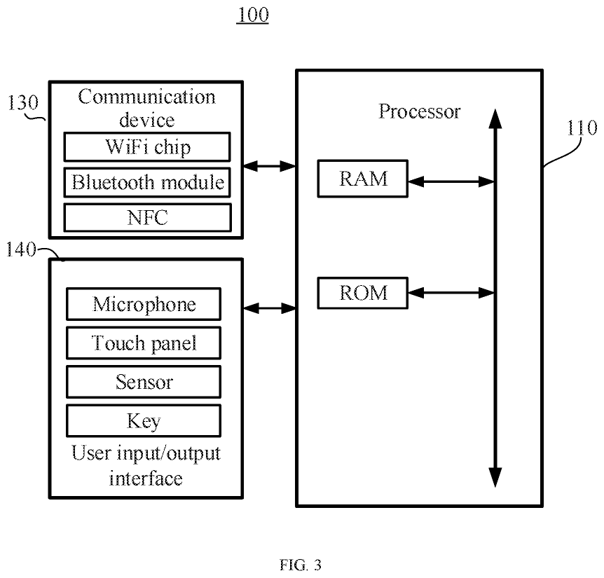

FIG. 3 is a hardware configuration block diagram of the control device shown in FIG. 1. As shown in FIG. 3, the control device 100 may include a processor 110, a communication device 130, a user input/output interface, a memory, and a power supply.

The control device 100 is configured to control the display apparatus 200, receive input operation commands from the user and convert the operation commands into instructions that can be recognized and responded to by the display apparatus 200, serving as an interaction intermediary between the user and the display apparatus 200.

In some embodiments, the control device 100 may be an intelligent device. For example, the control device 100 can install various applications for controlling the display apparatus 200 according to user needs.

In some embodiments, as shown in FIG. 1 described above, the mobile terminal 300 or other intelligent electronic devices can perform functions similar to the control device 100 after installing an application for controlling the display apparatus 200.

The processor 110 may include a RAM 113, a ROM 114, a communication device 130, and a communication bus. The processor 110 is configured to control the operation and running of the control device 100, as well as the communication and cooperation between internal components and the data processing function of external and internal parts.

Under the control of the processor 110, the communication device 130 realizes the communication of control signals and data signals with the display apparatus 200. The communication device 130 may include at least one of a WiFi chip 131, a Bluetooth module 132, an NFC module 133, and other near-field communication modules.

For the user input/output interface 140, the input interface includes at least one of a microphone 141, a touch panel 142, a sensor 143, a key 144, and the like.

In some embodiments, the control device 100 includes at least one of a communication device 130 and an input/output interface 140. The control device 100 is configured with a communication device 130, such as WiFi, Bluetooth, NFC and other modules, which can encode user input commands through the WiFi protocol, the Bluetooth protocol or the NFC protocol and send them to the display apparatus 200.

The memory 190 is configured to store various operating programs, data and applications for driving and controlling the control device 100 under the control of the processor. The memory 190 can store various control signal commands from the user.

The power supply 180 is configured to provide operating power support for components of the control device 100 under the control of the processor.

FIG. 4 is a software configuration block diagram of the display apparatus according to some embodiments. As shown in FIG. 4, the built-in system of the display apparatus can be divided into four layers, which are, from top to bottom, an application layer (Applications), an application framework layer (referred to as “framework layer”), an Android runtime and system library layer (referred to as “system runtime library layer”), and a kernel layer.

In some embodiments, at least one application runs in the application layer. These applications can be a window program, a system setting program, or a clock program that is built into the operating system; or applications developed by third-party developers. In specific implementation, the application packages in the application layer are not limited to the above examples.

The framework layer provides application programming interfaces (APIs) and programming frameworks for applications. The application framework layer includes some predefined functions. The application framework layer is equivalent to a processing center that determines the actions to be performed by the applications in the application layer. Through the APIs, the applications can access resources in the system and obtain system services during execution.

In some embodiments, the application framework layer in the embodiments of the present disclosure includes a view system, managers, a content provider, etc. The view system can design and implement the interface and interaction of the applications. The view system includes lists, grids, text boxes, buttons, etc. The managers include at least one of the following modules: an activity manager for interacting with all running activities in the system; a location manager for providing system location service access to system services or applications; a package manager for retrieving various information related to application packages currently installed on the device; a notification manager for controlling the display and clearing of notification messages; and a window manager for managing icons, windows, toolbars, wallpapers, and desktop widgets on the user interface.

In some embodiments, the activity manager is configured to manage the life cycle of each application and general navigation back functions, such as controlling the exiting, opening, and returning of applications. The window manager is configured to manage all window programs, such as obtaining a size of a display screen, determining whether there is a status bar, locking the screen, capturing the screen, and controlling changes of the display window (such as scaling down the display window, shaking the display window, distorting and deforming the display window for the display, etc.).

In some embodiments, the system runtime library layer provides support for the upper layer, that is, the framework layer. When the framework layer is used, the Android operating system runs the C/C++ libraries in the system runtime library layer to realize the functions to be realized by the framework layer.

In some embodiments, the kernel layer is a layer between hardware and software. As shown in FIG. 4, the kernel layer includes at least one of the following drivers: an audio driver, a display driver, a Bluetooth driver, a camera driver, a WIFI driver, a Universal Serial Bus (USB) driver, a High-Definition Multimedia Interface (HDMI) driver, a sensor driver (such as a fingerprint sensor, a temperature sensor, a pressure sensor, etc.), and a power driver.

After establishing a communication connection with the terminal device 500, the above display apparatus 200 can establish a casting connection channel and transmit casting screen data based on the casting connection, so that the display apparatus 200 can display the casting screen of the terminal device 500. In some embodiments, to establish a casting connection, the user can send a casting connection request through the terminal device 500, and send the casting connection request to the display apparatus 200 through a WiFi network. The display apparatus 200 then completes the transmission protocol configuration according to the casting connection request, thereby establishing a transmission channel for casting screen data with the terminal device 500.

The display apparatus 200 can also realize the casting connection with the terminal device 500 through different connection methods. For example, when the display apparatus 200 and the terminal device 500 access the same wireless local area network, the casting connection can be established based on the WiFi network. For another example, when both the display apparatus 200 and the terminal device 500 are provided with NFC components, the casting connection can be established through the NFC components. Obviously, other wired or wireless connection methods can also be adopted between the display apparatus 200 and the terminal device 500 to establish the casting connection, such as RF radio frequency connection, infrared connection, cellular network, and other connection methods that can be conceived by those skilled in the art based on the connection methods provided in the above embodiments.

After establishing the casting connection, the display apparatus 200 can receive screen casting-related data of the terminal device 500 through the casting screen data channel, to play screen casting-related content in the display apparatus 200. Under different casting screen data transmission protocols, the display apparatus 200 obtains different forms of casting screen data. For example, the display apparatus 200 and the terminal device 500 can establish a casting connection through protocols such as Digital Living Network Alliance (DLNA) protocol, Miracast protocol, AirPlay push protocol, WiDi screen casting, NFC screen mirroring, and Lebo screen casting.

The DLNA protocol is a protocol for realizing media resource sharing between devices. The protocol uses the network technology (wired or wireless) to interconnect various devices and perform data interaction through standard protocols, so that media resources can be shared between devices. The DLNA protocol is based on the Universal Plug and Play (UPnP) protocol, enabling devices to discover and control each other, and realizing seamless transmission and sharing of media resources. The DLNA protocol supports a variety of devices, including televisions, stereos, mobile phones, computers, etc., allowing users to seamlessly switch and share media content between different devices.

The Miracast protocol is a wireless display standard formulated by the Wi-Fi Alliance and based on Wi-Fi Direct. The Miracast casting protocol can be applied to Android devices, that is, Android devices can share video images through Miracast screen casting. Smart devices above Android 5.0 have a built-in Miracast protocol, so direct wireless screen casting can be performed through the WiFi Peer-to-Peer (P2P) function between the WiFi network interface cards of a casting device and a receiving device without installing any software. In addition, Miracast screen casting also supports synchronous transmission of audio and video.

The Airplay protocol is a wireless playback technology launched by Apple Inc., serving as a wireless casting protocol applicable to iOS and Mac systems. Apple series devices have a built-in Airplay screen casting function, which can be used with a screen projector that supports AirPlay server service, with clear and stable effects; and the protocol has a built-in screen casting code function. However, it is necessary to ensure that the Apple device and the screen projector are used in the same local area network (same network segment), and cannot be used across network segments or across Virtual Local Area Networks (VLANs).

WiDi screen casting is a wireless playback technology led by Intel, which is also based on the WiFi Direct technology. Windows Aug. 10, 2011 laptops natively support WiDi screen casting, enabling direct screen casting without installing any software, and supporting USB reverse control function.

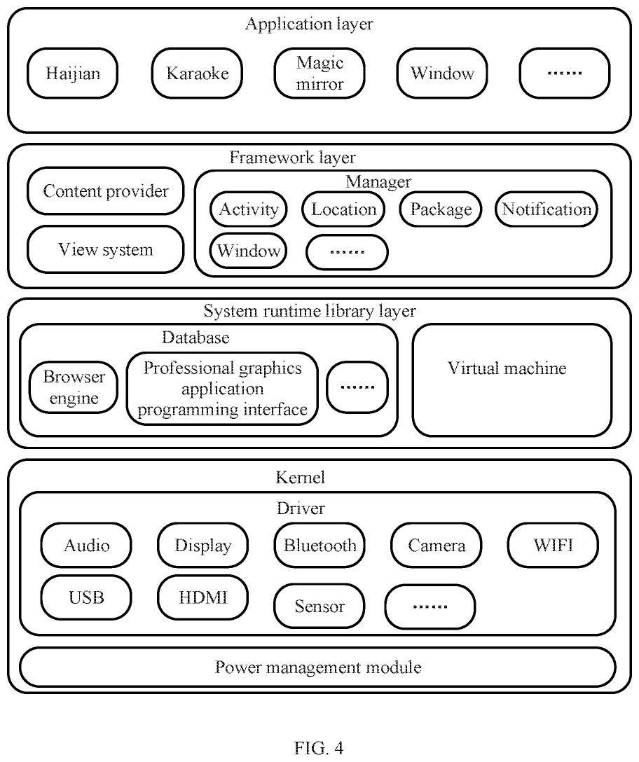

In some embodiments, after the display apparatus 200 establishes a casting connection with the terminal device 500, casting screen data can be transmitted through a mirror mode and a push mode. The mirror mode refers to the display apparatus 200 synchronously displaying the image content displayed in the terminal device 500. For example, as shown in FIG. 5, the display apparatus displays a main interface of the terminal device 500. When the user performs an interactive operation on the terminal device 500, resulting in a change in the content of the main interface, the content displayed by the display apparatus also changes accordingly. For this purpose, the terminal device 500 can generate a casting screen data stream in the form of video based on the displayed content, and send the casting screen data stream to the display apparatus for display.

The push mode refers to the display apparatus accessing a network link pushed by the terminal device 500 and obtaining the corresponding casting screen. For example, as shown in FIG. 6, when the terminal device 500 plays video media assets, a casting control is provided in the upper right corner of a playback interface. After the user clicks the casting control and selects the display apparatus as an apparatus for displaying the casting screen, the terminal device 500 can send a Uniform Resource Locator (URL) address of the currently played video media assets to the display apparatus. After receiving the URL address, the display apparatus accesses the URL address to obtain video media asset data and plays the video media assets.

Among the casting protocols supported by the display apparatus and the terminal device 500, some protocols are based on the mirror mode and some protocols are based on the push mode. For example, under the DLNA protocol, the display apparatus can obtain a link address of a certain resource in the terminal device 500 through the casting screen data channel, and obtain media asset content data by accessing the link address, thereby playing the media asset data. Meanwhile, when playing media asset data, the display apparatus can also obtain a control command from the terminal device 500 through the casting screen data channel, such as fast forward, pause, stop casting, etc. For example, after establishing a connection through a communication protocol, a terminal device 500 such as a mobile phone and a display apparatus may negotiate device functions and network conditions to select a suitable audio and video transmission format. After establishing a connection protocol (Session) for audio and video streaming, a series of Real-Time Streaming Protocol (RTSP) control commands are used to control the playback and termination of audio and video streaming.

Under other casting connection protocols such as Miracast screen casting, Airplay screen casting, NFC screen mirroring, and Lebo screen casting, the display apparatus can directly obtain the video data stream from the terminal device 500. The video data stream can be a video data stream corresponding to a final display image of a display unit of the terminal device 500, that is, the video data stream includes the media asset content image, User Interface (UI), and other video image content that can be displayed in the display unit of the terminal device 500. The video data stream can also be only the video data that can be obtained in the terminal device 500, such as the media asset video data being played. In this case, the terminal device 500 can be used as a signal source of the display apparatus, and the display apparatus can continuously obtain video data through the casting screen data channel and display the video data on the display in real time, realizing the effect of synchronous display with the terminal device 500.

It should be noted that the above casting protocols can not only obtain the video data stream in the terminal device 500, but also obtain the audio data stream in the terminal device 500, so that the video data and audio data can be sent to the display apparatus synchronously, enabling the display apparatus to play the video and audio synchronously.

The terminal device 500 can obtain different casting screen data based on different casting protocols. For example, for system applications or screen casting directly at a system level, the terminal device 500 can adopt Miracast screen casting, Airplay screen casting, or WiDi casting protocols to establish a casting screen data channel. Since the above Miracast casting protocol and Airplay casting protocol require system-level application permissions, the Miracast casting protocol and Airplay casting protocol are only applicable to system applications, or display apparatuses and terminal devices 500 of the same manufacturer directly establish a casting connection through built-in rules of the operating system.

The display apparatus can establish a casting connection with the terminal device 500 based on any of the casting methods provided in the above embodiments. In some embodiments, the display apparatus can also establish casting connections with multiple communication terminals through one or more of the above casting methods. For example, the display apparatus can establish casting connections with a first terminal device 510 and a second terminal device 520 at the same time, and divide display areas in a display screen for displaying the casting screens shared by the first terminal device 510 and the second terminal device 520 respectively.

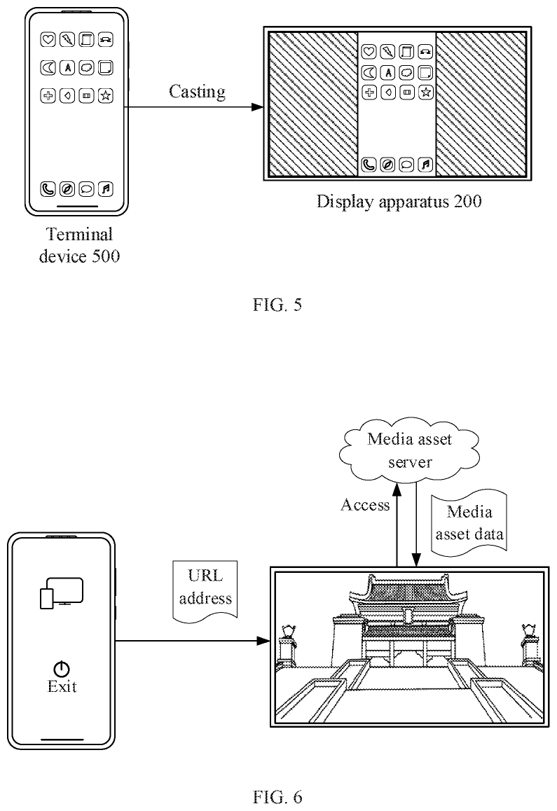

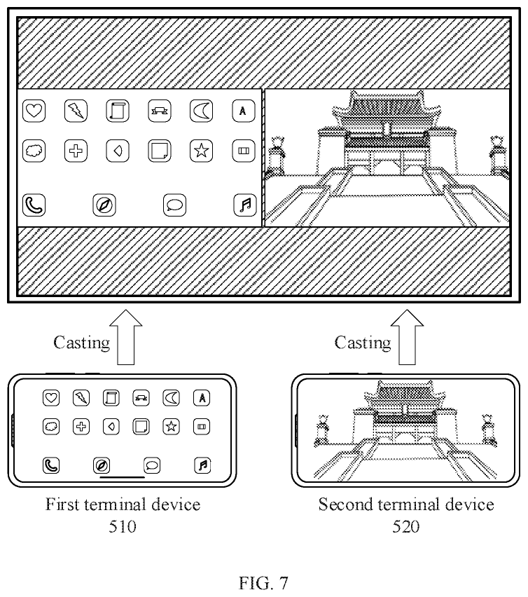

To display casting screens shared by multiple terminal devices 500 on a display apparatus, in some embodiments, when the display apparatus establishes casting connections with multiple terminal devices 500, the display apparatus can display a multi-channel casting interface. The multi-channel casting interface may include multiple casting windows. The casting window is used to display the casting screen of the corresponding terminal device 500 over one casting connection channel. For example, as shown in FIG. 7, the multi-channel casting interface may include two casting windows, namely a first casting window and a second casting window. The first casting window is used to display the casting screen of the first terminal device 510. The second casting window is used to display the casting screen of the second terminal device 520.

It should be noted that there may not be a strong binding relationship between the casting windows in the multi-channel casting interface and the terminal devices 500. That is, in some embodiments, the display content of the casting windows can be determined according to the order in which the terminal devices 500 establish casting connections with the display apparatus. For example, when the first terminal device 510 establishes a casting connection with the display apparatus earlier than the second terminal device 520, the first casting window located on the left side of the multi-channel casting interface displays the casting screen of the first terminal device 510. When the first terminal device 510 establishes a casting connection with the display apparatus later than the second terminal device 520, the first casting window located on the left side of the multi-channel casting interface displays the casting screen of the second terminal device 520.

To obtain a better image display effect and improve the coordination of the multi-channel casting interface, in some embodiments, the display apparatus can also perform layout settings on the casting windows. As shown in FIG. 8, the display apparatus can have multiple functional modules built into the same application, such as a multi-channel casting application. The multi-channel casting application includes: a data management module, a message processing module, a service management module, an algorithm processing module, a View management module, an application interaction processing module, a position management module, a replacement management module, a playback control management module, a time management module, a focus management module, and a casting management module, etc.

The data management module mainly manages all message data involved in the current casting application and updates data information synchronously. The message processing module is mainly responsible for the transmission of relevant messages between different modules, such as transmitting data changes to the View layer for refresh display, or synchronizing View changes to the data management module for processing changes such as playback control data. The service management module is responsible for starting and shutting down services of the entire application as well as some customized processing, such as starting specific services in specific scenarios. The algorithm processing module is responsible for calculating all layout positions in the entire application. The View management module is mainly responsible for all UI displays of the entire casting application and receiving data to refresh the display of the View.

The application interaction processing module is responsible for processing interactions with external applications. For example, any entry that starts the current casting application needs to interact with this module, and different customized management is performed according to the differences of the startup entries. The position management module is responsible for the rule of displaying casting positions in the left and right windows, such as determining whether to display on the left or right side. The replacement management module is responsible for the replacement rule when the number of casting channels exceeds the maximum display number, such as how to replace when there is a focus or no focus. The playback control management module is responsible for the playback control processing of different media asset types during screen casting, such as fast forward, fast rewind, play and pause, etc. The time management module is responsible for the timing processing of focus display during screen casting, whether it is a large-frame focus or a playback control position focus. The focus management module is responsible for the focus display and key processing in the entire application. The casting management module is responsible for casting protocol interaction, client list management, and status information processing of the display content of the window.

It should be noted that the multi-channel casting interface can realize image display based on a multi-channel casting viewing application. As an application that can display content such as multi-protocol multi-channel screen mirroring and push, the multi-channel casting viewing application is an upper-layer application inside the display apparatus. The framework layer of the display apparatus can provide Java interfaces for hardware docking and the like. The multi-channel casting viewing application realizes docking with lower layers and acquisition of information through the Java interfaces of the framework layer. Other layers such as the Native layer, Runtime layer, Hardware Abstraction Layer (HAL), and Linux kernel are all standard layers of the Android architecture, and each layer performs interactive processing according to the business process.

The display apparatus first starts the application through the service management module and performs some initial preparation work, such as starting the protocol service that monitors mirroring or push. The View management module initializes the view displayed at the application layer. The data management module creates data for relevant data processing modules. The algorithm processing module performs algorithm layout calculation on the casting content. The position management module is responsible for positioning the left and right positions of the casting content, etc.

During the process of establishing a casting connection, the service management module can start the casting application and register listeners for the Session, as well as the Usession Connection Listener, Usession Prepare Listener, USession Display Listener and Usession Event Listener. Herein, Session represents a session between the client and the server, and can save the information of the client side. Usession Connection Listener is used to monitor the connection and disconnection events of the Session. Usession Prepare Listener interacts with the casting preparation of the client side. Usession Display Listener monitors changes in playback information and status as well as status changes of the client side. Usession Event Listener processes client operations and other related information.

After completing the initialization of the View, the display apparatus may display a default guide window when entering the application. The guide window is used to display a guide page. The guide page may display some device information, such as the device name of the current display apparatus and the corresponding network information, etc. That is, the guide page may include multiple system-standard TextViews and ImageViews. The display apparatus can display the guide page in equal proportions on the left and right sides by controlling the controls TextView, ImageView and the corresponding Layout, as shown in FIG. 9. The guide page includes a reference resolution, and the display apparatus needs to scale the guide page according to the reference resolution when displaying the guide page through the guide window.

In some embodiments, the guide window shares a root with the multi-channel casting interface, that is, the guide window and the multi-channel casting interface share the same root node. For example, after the user launches the multi-channel casting application on the display apparatus, the display apparatus controls the display to display the multi-channel casting interface in the full screen, and displays the guide window at the corresponding position of the multi-channel casting interface. The multi-channel casting interface is a home page interface of the multi-channel casting application, and the guide window and the home page interface of the multi-channel casting application share the same root.

After displaying the guide window, the display apparatus can monitor and receive a casting connection command sent from the terminal device 500, and establish a casting connection channel according to the casting connection command, thereby displaying the casting screen of the terminal device in the casting window.

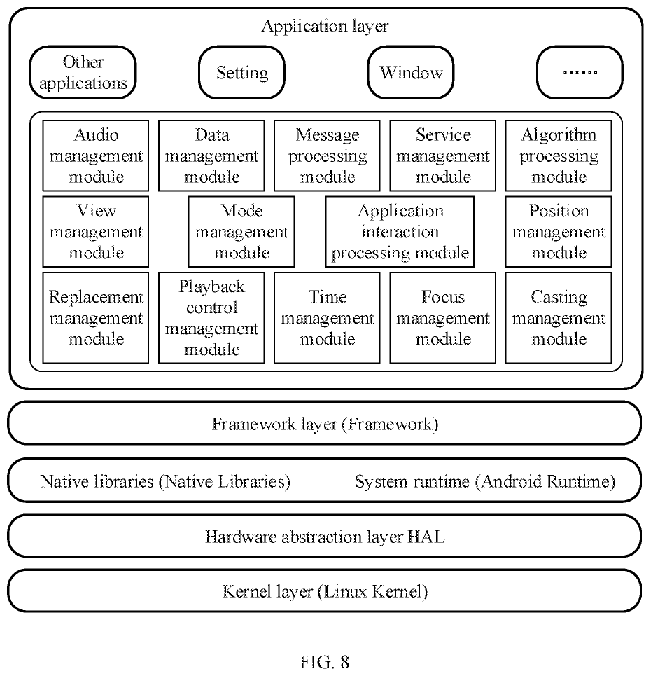

Some embodiments of the present disclosure provide a display apparatus, including a display, a user input interface, a communication device, a memory, and at least one processor. The display is configured to display a multi-channel casting interface, and the multi-channel casting interface includes a first guide window and a second guide window. The first guide window and the second guide window are configured to display guide pages; and the first guide window, the second guide window and the multi-channel casting interface share the same root node. The communication device is configured to establish a communication connection with the terminal device 500. In a multi-channel casting scenario, on the premise of displaying the casting windows of multiple terminal devices at the same height, the display apparatus can calculate the display area of each window based on the screen resolution, the resolution of the casting screen and the resolution of the guide page, so that the casting screen can be displayed in the multi-channel casting interface to the greatest extent, improving the user experience. Specifically, as shown in FIG. 10, it includes the following steps.

S1001: In response to a casting connection command sent from a first terminal device, a first casting window is created, the first guide window is released, and the display of the second guide window in the multi-channel casting interface is retained.

After the display apparatus displays the default guide window, the user can establish a communication connection between the terminal device 500 and the display apparatus based on prompt information in the guide window. After the user sends a casting connection command to the display apparatus through the first terminal device 510, the display apparatus creates a first casting window in response to the casting connection command. The first casting window is configured to display a first casting screen, and the first casting window shares the same root node as the multi-channel casting interface, that is, the first casting window also shares the same root as the multi-channel casting interface.

For example, the casting management module of the display apparatus is always ready for the access of a new Session. When the first terminal device 510 Client1 is ready to initiate a connection, the casting management module listens to the onConnect connection event of a new Session through the UsessionConnectionListener, and then executes the creation of the first casting window. The first casting window may include a playback control SurfaceView/TextureView, and the display apparatus can set the first casting screen to the corresponding position of the SurfaceView/TextureView.

While creating the first casting window, the display apparatus also releases the first guide window, so that the first guide window does not appear in the multi-channel casting interface. At the same time, the display of the second guide window in the multi-channel casting interface is retained. When releasing the first guide window, the display apparatus can release relevant resources of the window object corresponding to the first guide window.

To facilitate the management of the display orientation of the casting window, in some embodiments, when creating the first casting window, the display apparatus also sets an orientation identifier of the first casting window through a position management module. The orientation identifier is used to indicate a display orientation of the casting window. The display apparatus can display the first casting window according to the orientation identifier. When setting the orientation identifier, the display apparatus can set the orientation identifier of the casting window according to the casting sequence of the terminal devices 500 in compliance with the default priority order. The orientation identifiers can be different numbers or English characters. For example, the display orientation of the casting window includes left and right sides, the default priority order is left>right, the orientation identifier of the left side is 1, and the orientation identifier of the right side is 2. In response to receiving the casting connection command of the first terminal device 510, the position management module sets the orientation identifier of the first casting window to 1 according to the default priority order, that is, setting mViewPosition: 1.

To facilitate the management of the first casting session between the first casting window and the first terminal device 510, in some embodiments, the display apparatus is also provided with a management object MultiCastPlayView. The management object MultiCastPlayView can be associated with information such as Session, SurfaceView/TextureView and mViewPosition. For example, for the first terminal device 510, the data corresponding to its Client1 can be expressed as: Session: SessionClient1, View: SurfaceView/TextureView, MViewPosition: 1.

S1002: A first casting session sent from the first terminal device is obtained.

After completing the creation of the first casting window, the display apparatus obtains the first casting session sent from the first terminal device 510, to obtain casting screen data information sent by the first terminal device 510 through the first casting session. The casting screen data information includes information associated with the casting connection between the first terminal device and the display apparatus, such as the resolution and other attributes of the first casting screen. That is, the first casting session includes a first resolution of the first casting screen. By obtaining the first casting session SessionClient1, the display apparatus can obtain the first resolution of the first casting screen, and then calculate a display area of the first casting window based on the first resolution.

For example, after the display apparatus prepares the view of the first casting window, the display apparatus can notify the first terminal device Client1 via the UsessionPrepareListener to record or send the video stream. When the terminal device 500 is ready to send video information, the display apparatus learns that the first casting screen is about to be played through the method onFirstFrame( ) of the UsessionDisplayListener, and thus obtains the first resolution of the first casting screen corresponding to the current Client1 from SessionClient1, that is, the width and height of the video stream. Then the display apparatus determines the orientation of the current video stream, and calculates the display position and size of the current view through an algorithm.

S1003: A screen resolution and a reference resolution of the guide page are detected.

After the display apparatus releases the first guide window and creates the first casting window, windows displayed in the multi-channel casting interface include the first casting window and the second guide window. Therefore, after obtaining the first resolution of the first casting screen in the first casting session, the display apparatus detects the screen resolution of the display apparatus and the reference resolution of the guide page, to determine display areas of the first casting window and the second guide window through the screen resolution, the first resolution of the first casting screen and the reference resolution of the guide page.

Herein, the screen resolution and the reference resolution of the guide page are pre-stored information in the display apparatus, and the display apparatus can detect the screen resolution of the display apparatus and the reference resolution of the guide page at a specified storage location. For example, the reference resolution of the guide page can be stored in a layout file of the multi-channel casting application, and the display apparatus can detect layout information of the guide page in the layout file to obtain the reference resolution.

S1004: A window display area is calculated according to the screen resolution, the first resolution and the reference resolution.

After obtaining the screen resolution, the first resolution and the reference resolution, the display apparatus can calculate the display area of each window according to the above resolutions. Herein, the window display area includes a first display area and a second display area. The first display area is configured to display the first casting window, and the second display area is configured to display the second guide window. To improve the user's visual experience, a height of the first display area and a height of the second display area are equal, so that each window can maintain a consistent height, avoiding the problem that the users repeatedly switches their visual focus between different heights when viewing multiple windows at the same time.

In some embodiments, when the display apparatus calculates the window display area according to the screen resolution, the first resolution and the reference resolution, the display apparatus reads a horizontal pixel value and a vertical pixel value of the screen resolution. Then the display apparatus calculates a first aspect ratio according to a ratio of the horizontal pixel value to the vertical pixel value in the first resolution, and calculates a second aspect ratio according to a ratio of the horizontal pixel value to the vertical pixel value in the reference resolution. For example, the screen resolution of the display apparatus is 1920×1080, the first resolution of the first casting screen is 1920×1080, and the reference resolution of the guide page is 954×538. For the screen resolution, the horizontal pixel value is 1920, and the vertical pixel value is 1080. For the first resolution, the horizontal pixel value is 1920, the vertical pixel value is 1080, and the ratio of the two is calculated to obtain the first aspect ratio of 16/9. For the reference resolution, the horizontal pixel value is 954, the vertical pixel value is 1080, and the ratio of the two is calculated to obtain the second aspect ratio of 477/269, which is close to 16/9.

Then a first layout parameter and a second layout parameter are set. Herein, the first layout parameter includes a first layout width and a first layout height, and the second layout parameter includes a second layout width and a second layout height. The first layout height is equal to the second layout height, a sum of the first layout width and the second layout width is equal to the horizontal pixel value of the screen resolution, the first layout height and the second layout height are both less than or equal to the vertical pixel value of the screen resolution, a ratio of the first layout width to the first layout height is equal to the first aspect ratio, and a ratio of the second layout width to the second layout height is equal to the second aspect ratio. Then the first display area is generated according to the first layout parameter and the second display area is generated according to the second layout parameter.

To improve the standardization of the layout of each window, in some embodiments, the multi-channel casting interface of the display apparatus includes an edge area. The edge area is a display area in the multi-channel casting interface except the display window and the guide window, which can be called a blank area. In addition, the edge area can also be used to display playback function controls or prompt information, etc. Therefore, a sum of the layout height and a height of the edge area is set to be equal to the vertical pixel value of the screen.

In some embodiments, when setting the first layout parameter, the display apparatus reads a first preset height of the edge area. Herein, the edge area includes the display area in the multi-channel casting interface except the first casting window and the second guide window. Then a sum of the first layout height and the first preset height is set to be equal to the vertical pixel value of the screen resolution to generate the first layout height based on the first preset height.

Taking the screen resolution of the display apparatus of 1920×1080 as an example, when the display apparatus sets the aforementioned first layout parameter and second layout parameter, according to the first resolution and the reference resolution, it configures Client1: width1, height1; and Guide (guide page): width_guide, height_guide. Herein, width1 and height1 correspond to the first layout width and the first layout height respectively; and width_guide and height_guide correspond to the second layout width and the second layout height respectively. The height from the first casting window to the top edge of the screen, namely the first preset height, is defined as top. Given that height1 and height_guide are of equal height, they can be replaced with the same variable height. The first aspect ratio ratio1 of the first casting screen and the second aspect ratio ratio_guide of the guide page are both known constants. The values of width1, top, height and width_guide can be derived through the following combined calculations: width1+width_guide=1920; top*2+height=1080; width1/height=ratio1; width_guide/height=ratio_guide.

To facilitate distinguishing each window, in some embodiments, a blank area is provided between the first casting window and the second guide window; and/or blank areas are provided between the first casting window and the left edge of the screen, and between the second guide window and the right edge of the screen. When setting the layout parameters, the display apparatus also sets a sum of the layout width and the width of the blank area to be equal to the horizontal pixel value of the screen. For example, a width from the casting screen to the left edge is defined as left, a width from the guide page to the right edge is defined as right, and the blank area between the first casting window and the guide window is set to 12 pixels. Given that the screen resolution of the display apparatus is 1920×1080, the equation width1+width_guide+left+right+12=1920 is thus configured.

S1005: The display is controlled to display the first casting window in the first display area and display the second guide window in the second display area.

After calculating the first display area and the second display area, the display apparatus displays the first casting window in the first display area and displays the second guide window in the second display area. By calculating the first display area and the second display area through the aforementioned algorithm, and displaying the first casting window in the first display area and the second guide window in the second display area, the first casting window can be displayed to the greatest extent on the premise that the two windows are of equal height, standardizing the layout of each window, thereby improving the user's visual experience.

In some embodiments, when the display apparatus displays the first casting window in the first display area, the display apparatus generates layout position coordinates of the first casting window according to the first layout parameter, records the first layout parameter and the layout position coordinates, and then draws the first casting window according to the first layout parameter and the layout position coordinates.

Similarly, in some embodiments, when the display apparatus displays the second guide window in the second display area, the display apparatus generates layout position coordinates of the second guide window according to the second layout parameter, records the second layout parameter and the layout position coordinates, and then draws the second guide window according to the second layout parameter and the layout position coordinates.

For example, the screen resolution of the display apparatus is 1920×1080, the first resolution of the first casting screen is 512×1088, the reference resolution of the guide page is 954×538, and the width of the blank area between the first casting window and the second guide window is 12 pixels. The first layout parameter and the second layout parameter are calculated based on the algorithm of width1+width_guide=1920; top*2+height=1080; width1/height=ratio1; width_guide/height=ratio_guide, where top=116. The calculation result shows that in the first layout parameter, the first layout height is 848 and the first layout width is 400. According to the above layout parameters, it's derived that the top-left corner coordinates of the first casting window are (0, 116), and the top-left corner coordinates of the guide window are (412, 116). The aforementioned layout parameters and top-left corner coordinates are then stored by the data management module, and the data is transmitted to the View management module through a message processing module, so that the View management module draws the first casting window and the second guide window according to the layout parameters and the top-left corner coordinates.

That is, the data management module of the display apparatus can sort out and store the layout parameters and layout position coordinates, and then transmit the data, including: Session: SessionClient1, View: SurfaceView/TextureView, MViewPosition: 1, Position: (0, 116), Width: 400, Height: 848; Session: View: layout, MViewPosition: Position: (412, 116), Width: 1508, Height: 848. After receiving the data information, the View management module of the display apparatus sets display parameters through LayoutParams, including the top-left corner coordinates, as well as the corresponding layout width and layout height, and then displays the position through the setLayoutParams method. That is:

FrameLayout. LayoutParams lp1=new FrameLayout. LayoutParams(width, height, 0); lp1.width=400; lp1.height=848; lp1.leftMargin=0; lp1.topMargin=116; mPlayerView. setLayoutParams(lp1); FrameLayout. LayoutParams lp1=new FrameLayout. LayoutParams(width, height, 0); lp1.width=1508; lp1.height=848; lp1.leftMargin=412; lp1.topMargin=116; mPlayerView.setLayoutParams(lp1).

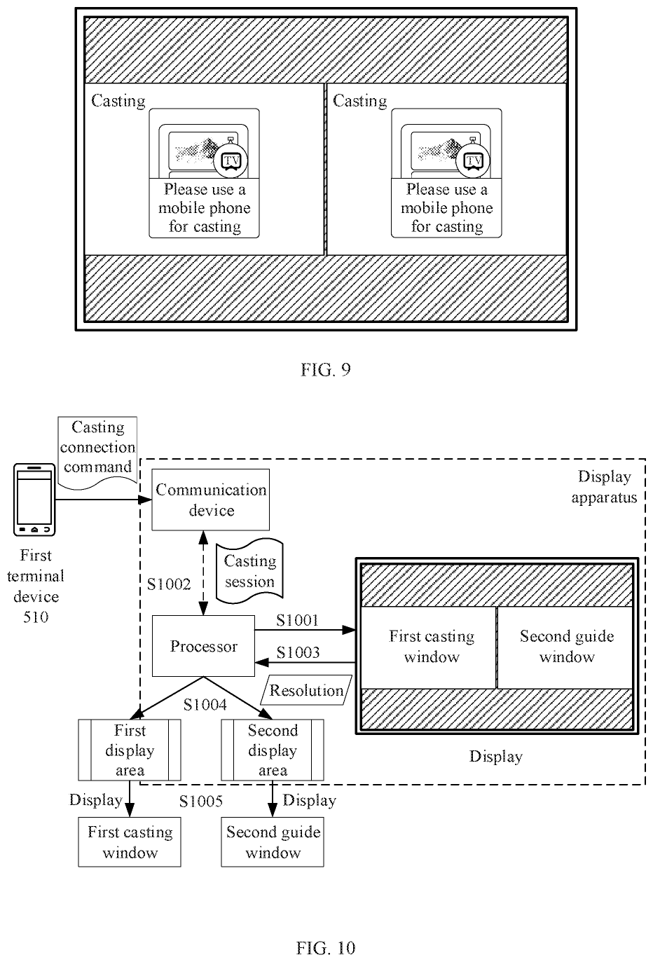

By setting the display position of SurfaceView/TextureView and the display position of the guide page Layout through the View management module respectively, the display effect of the multi-channel casting interface shown in FIG. 11 can be obtained.

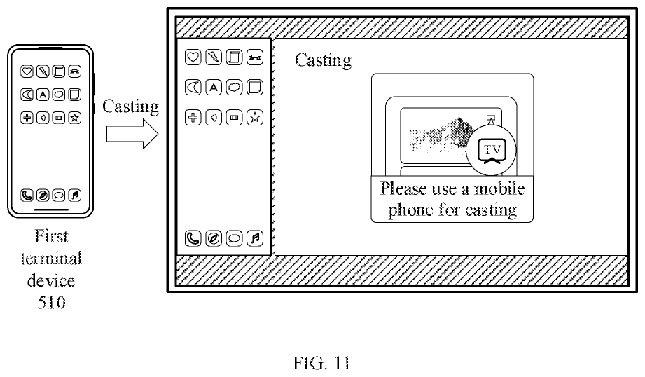

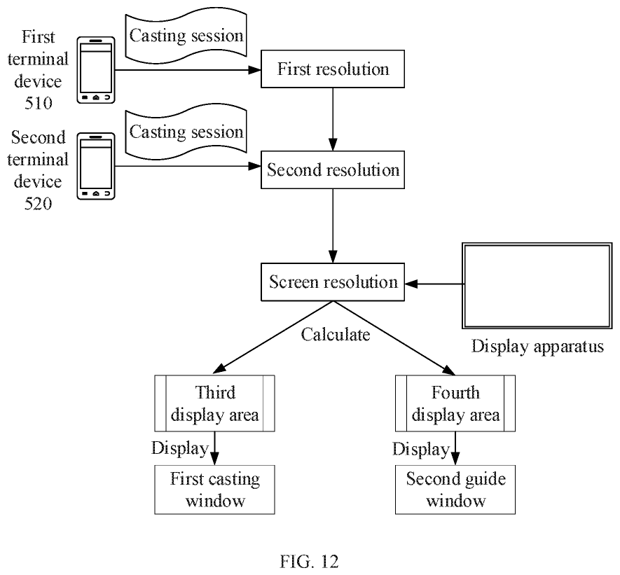

After displaying the multi-channel casting interface shown in FIG. 11, the display apparatus can also receive a casting connection command sent from another terminal device 500 and establish a casting connection with the terminal device. For example, as shown in FIG. 12, the display apparatus can also create a second casting window and release the second guide window in response to a casting connection command sent from the second terminal device 520. Herein, the second casting window is configured to display a second casting screen of the second terminal device 520, and the second casting window shares the same root node as the multi-channel casting interface. Then the display apparatus obtains a second casting session sent from the second terminal device 520. Herein, the second casting session includes a second resolution of the second casting screen. Then the display apparatus detects the screen resolution and the first resolution, and calculates a window display area according to the screen resolution, the first resolution and the second resolution. The window display area includes a third display area and a fourth display area, and a height of the third display area and a height of the fourth display area are equal. Then the display apparatus controls the display to display the first casting window in the third display area and controls the display to display the second casting window in the fourth display area.

In some embodiments, when the display apparatus calculates the window display area according to the screen resolution, the first resolution and the second resolution, the display apparatus calculates a third aspect ratio according to a ratio of the horizontal pixel value to the vertical pixel value in the second resolution. The display apparatus sets a third layout parameter and a fourth layout parameter. Herein, the third layout parameter includes a third layout width and a third layout height, and the fourth layout parameter includes a fourth layout width and a fourth layout height, with the third layout height equal to the fourth layout height. A sum of the third layout width and the fourth layout width is equal to the horizontal pixel value of the screen resolution, the third layout height and the fourth layout height are less than or equal to the vertical pixel value of the screen resolution, a ratio of the third layout width to the third layout height is equal to the first aspect ratio, and a ratio of the fourth layout width to the fourth layout height is equal to the third aspect ratio.

For example, the screen resolution of the display apparatus can be 1920×1080, and the first resolution of the first casting screen can be 512×1088. After the display apparatus displays the casting window of the first terminal device Client1, the display apparatus then detects a new casting connection command sent from the second terminal device Client2, and synchronously creates a second casting window View corresponding to the second terminal device 520. After the View is successfully created, the position management module is activated to set and manage the display position of SessionClient2, with the position management module processing and acquiring the relevant data. Since the first casting window is already displayed on the left side, the orientation identifier of the second casting window is set to the right side, that is, the mViewPosition of Client2 is marked as 2.

The View management data of the management object includes: Session: SessionClient2; View: SurfaceView/TextureView; MViewPosition:2. The second resolution of the second casting screen obtained is 1552×1088. The step of calculating the layout parameters and layout position coordinates of the first casting window and the second casting window according to the above algorithm and storing the derived layout parameters and layout position coordinates in the data management module can be expressed as:
Session: SessionClient 1; View: SurfaceView/TextureView; MViewPosition: 1; Position:(0, 37); Width: 473; Height: 1006;
Session: SessionClient 2; View: SurfaceView/TextureView; MViewPosition: 2; Position:(485, 37); Width: 1435; Height: 1006.

After the data management module records the above data information, the data management module transmits the data information to the View management module through the message management module, and then the View management module displays the position through the setLayoutParams method according to the transmitted data information.

That is: FrameLayout. LayoutParams lp1=new FrameLayout.LayoutParams(width, height, 0); lp1.width=473; lp1.height=1006; lp1.leftMargin=0; lp1.topMargin=37; mPlayerView.setLayoutParams(lp1);
FrameLayout.LayoutParams lp1=new FrameLayout.LayoutParams(width, height, 0); lp1.width =1435; lp1.height=1006; lp1.leftMargin=485; lp1.topMargin=37; mPlayerView.setLayoutParams(lp1).

By setting the display positions of the SurfaceView/TextureView corresponding to the first casting window and the second casting window separately via the View management module, the display effect of the multi-channel casting interface shown in FIG. 13 can be achieved. The display apparatus displays the first casting window and the second casting window at the same height, and at the same time, both windows can be displayed on the multi-channel casting interface to the greatest extent.

After displaying the casting window of the terminal device 500, the display apparatus can also terminate the casting connection between the display apparatus and the terminal device 500 in response to a casting termination command corresponding to the terminal device 500, and remove the casting window of the terminal device 500. In some embodiments, the casting termination command can be input on the display apparatus side, or input on the terminal device side, or may be automatically generated due to external reasons such as network problems.

Therefore, in some embodiments, the display apparatus monitors a casting connection session of the terminal device 500. After detecting the casting termination command for the first casting session, in response to the casting termination command for the first casting session, the display apparatus removes the first casting window, and calls the first guide window. Since the first guide window was released when displaying the first casting window, the first guide window needs to be re-called after the display apparatus removes the first casting window. For example, the display apparatus re-calls the relevant resources of the window object corresponding to the first guide window. Then the display apparatus detects the screen resolution and the second resolution, and calculates the window display area according to the screen resolution, the second resolution and the reference resolution. Herein, the window display area includes a fifth display area and a sixth display area, and a height of the fifth display area and a height of the sixth display area are equal. After calculating the fifth display area and the sixth display area, the display apparatus controls the display to display the first guide window in the fifth display area and controls the display to display the second casting window in the sixth display area.

In some embodiments, when the display apparatus calculates the window display area according to the screen resolution, the second resolution and the reference resolution, the display apparatus sets the fifth layout parameter and the sixth layout parameter. Herein, the fifth layout parameter includes a fifth layout width and a fifth layout height, and the sixth layout parameter includes a sixth layout width and a sixth layout height, with the fifth layout height equal to the sixth layout height. A sum of the fifth layout width and the sixth layout width is equal to the horizontal pixel value of the screen resolution, the fifth layout height and the sixth layout height are less than or equal to the vertical pixel value of the screen resolution, a ratio of the fifth layout width to the fifth layout height is equal to the third aspect ratio, and a ratio of the sixth layout width to the sixth layout height is equal to the second aspect ratio.

It can be understood that the algorithm adopted by the display apparatus when calculating the fifth layout parameter and the sixth layout parameter is the same as the algorithm for calculating the first layout parameter, the second layout parameter, the third layout parameter, and the fourth layout parameter, which will not be repeated here.

Since the terminal device 500 may be in different placement states according to different usage modes, for example, for a terminal device 500 such as a smartphone, it may be in a portrait state or a landscape state during use. Herein, the portrait state refers to a state where a width of the displayed image is smaller than a height, and the landscape state refers to a state where the width of the displayed image is larger than the height. In different placement states, the terminal device 500 can present different image layout modes.

Based on this, in some embodiments, when the placement states of the terminal device 500 are different, the resolution of the casting screen is also different, that is, the casting screen will present different image ratios in different placement states. For example, when the first terminal device 510 is in a landscape state, the resolution of the first casting screen is 1920×1080; when the first terminal device 510 is converted to a portrait state, the size of the first casting screen is 1080×1920.

Obviously, when the resolution of the casting screen changes, the display apparatus also needs to recalculate the display area of the casting window according to the resolution of the casting screen after the change. Therefore, in some embodiments, when only the first casting window is displayed in the multi-channel casting interface, the display apparatus also monitors a change event of the first casting session. In response to detecting a change event of the first resolution, the display apparatus detects a changed resolution of the first casting screen. Herein, the changed resolution is a resolution of the first casting screen after the change event is executed. Then the display apparatus calculates the window display area according to the screen resolution, the changed resolution and the reference resolution. The window display area includes a seventh display area and an eighth display area, and a height of the seventh display area and a height of the eighth display area are equal. Then the display apparatus controls the display to display the first casting window in the seventh display area and controls the display to display the second guide window in the eighth display area.

Similarly, in some embodiments, when only the second casting window is displayed in the multi-channel casting interface, the display apparatus also monitors a change event of a second casting session. In response to detecting a change event of the second resolution, the display apparatus detects a changed resolution of the second casting screen. Herein, the changed resolution is a resolution of the second casting screen after the change event is executed. Then the display apparatus calculates the window display area according to the screen resolution, the changed resolution and the reference resolution. The window display area includes a ninth display area and a tenth display area, and a height of the ninth display area and a height of the tenth display area are equal. Then the display apparatus controls the display to display the first guide window in the ninth display area and controls the display to display the second casting window in the tenth display area.

In some embodiments, when both the first casting interface and the second casting interface are displayed in the multi-channel casting interface, the display apparatus monitors the change events of the first casting session and the second casting session. In response to detecting a change event of the first resolution and/or the second resolution, the display apparatus calculates the window display area according to the refreshed resolution after the change event is executed and the screen resolution. That is, when the display apparatus detects a resolution change event in any casting session, the display apparatus recalculates the window display area to display the casting window according to the newly calculated window display area.

For example, after the display apparatus establishes casting connections with the first terminal device 510 and the second terminal device 520, the display apparatus displays the multi-channel casting interface shown in FIG. 13. The display apparatus can monitor the first casting session through the onVideoChanged( ) method of the UsessionDisplayListener via the casting management module. When detecting that the first terminal device 510 changes from the portrait state to the landscape state, that is, when the first resolution changes, the changed first resolution is notified to the algorithm processing module through the message processing module, so that the algorithm processing module recalculates the layout parameters and layout position coordinates of each window through the algorithm provided in the above embodiments. After the calculation is completed, the algorithm processing module notifies the View management module of the data information through the message processing module, and the View management module then re-layouts the first casting window and the second casting window according to the transmitted data information, presenting the effect shown in FIG. 14.

To make full use of the display space of the multi-channel casting interface and reduce large-area blank areas, in some embodiments, after displaying the first casting window, the display apparatus also calculates a window aspect ratio of the first casting window according to the first layout width and the first layout height, and compares the window aspect ratio with the first aspect ratio. Based on that the window aspect ratio is not equal to the first aspect ratio, the display apparatus scales the first casting screen in the first casting window. In other words, when the aspect ratio of the casting window is inconsistent with that of the casting screen, it indicates that there are other blank areas in the casting window besides the display area of the casting screen. The display apparatus can scale the casting screen in the casting window to reduce the blank areas in the casting window.

To facilitate user interaction with the casting window, in some embodiments, when displaying the multi-channel casting interface, the display apparatus can also display playback function controls in the multi-channel casting interface. The user can perform interactive operations through the playback function controls to input control commands and control the display apparatus to execute interactive responses. For example, the casting content of the display apparatus and the terminal device 500 is diverse, including mirrored video streams, pushed URL addresses, images, music and other different media asset types, and thus the playback function controls for different media asset types are also different. For example, video screen mirroring does not support fast forward and fast rewind operations, and also does not support play and pause operations; pushed URL addresses can support fast forward, fast rewind, play, pause and other operations; music can support fast forward, fast rewind, play, pause and other operations; and pictures do not support fast forward, fast rewind, play, pause, etc.

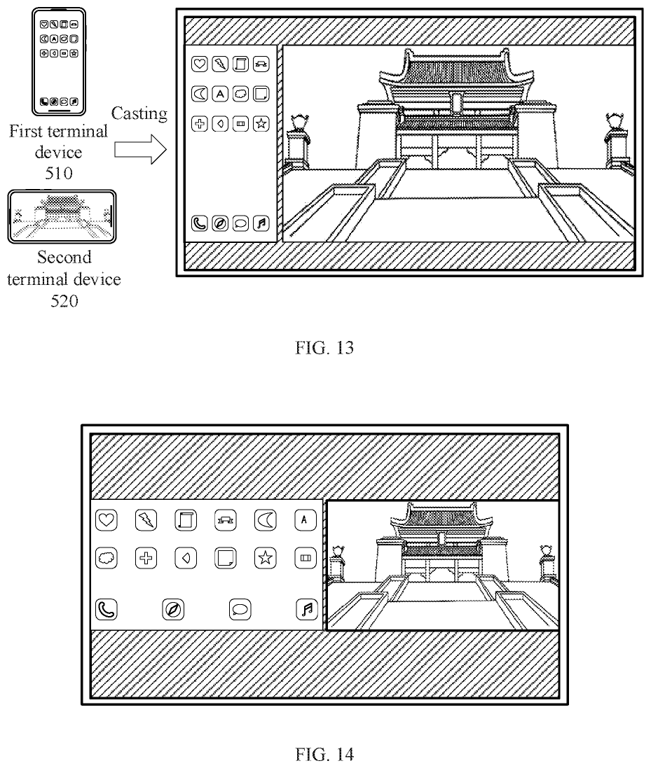

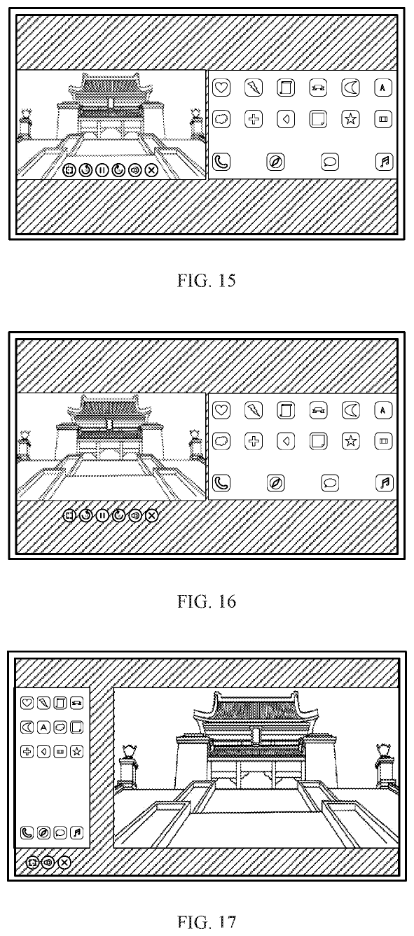

In some embodiments, the playback function controls of the display apparatus can be displayed above the casting screen in a floating manner, as shown in FIG. 15. Or, the playback function controls of the display apparatus can also be displayed in an edge area of the multi-channel casting interface, as shown in FIG. 16. For example, the display apparatus can display the above playback function controls when a focus event of the casting window is detected.

To balance the display area of the casting window and the display effect of the playback function controls, for the scenario where the playback function controls are displayed in the edge area, in some embodiments, after the display apparatus displays the first casting window in the first display area, in response to a focus event of the first casting window, the display apparatus controls the display to display the playback function control of the first casting window in the edge area. The display apparatus reads a second preset height of the edge area. Herein, the second preset height is greater than the first preset height. Then the display apparatus sets the sum of the first layout height and the second preset height to be equal to the vertical pixel value of the screen resolution to generate the first layout height based on the second preset height. In other words, when displaying the playback function control in the edge area, the display apparatus can also proportionally compress the display area of the casting window or the guide window, thereby increasing the edge area of the multi-channel casting interface to facilitate the display of the playback function control.

Alternatively, in response to the focus event of the first casting window, the display apparatus controls the display to display the playback function controls of the first casting window in the edge area, and detects the maximum display height when displaying the playback function controls. Then the display apparatus calculates the first layout height of the first casting window according to the maximum display height.

For example, after the display apparatus establishes casting connections with the first terminal device 510 and the second terminal device 520, the display apparatus displays the multi-channel casting interface shown in FIG. 13. In this case, the layout height of the first casting window and the second casting window is 1006. In this case, the user clicks the first casting window, and the display apparatus detects that the maximum display height when displaying the playback function controls is 864. Then it is necessary to reset the layout parameters of the first casting window and the second casting window, changing the layout height of the first casting window and the second casting window from 1006 to 864 while proportionally compressing the first casting window and the second casting window. The display apparatus sets Client 1: width1, height1; Client2: width2, height2. The values of width1, top, height, and width_guide can be calculated through the following combined calculation: width1/height1=ratio1; width2/height2=ratio2. By resetting height1 and height2 to 864, width1 and width2 can be obtained according to the aforementioned ratios. In this case, the data stored in the data management module includes:
Session: SessionClient1; View: SurfaceView/TextureView; MViewPosition: 1; Position:(0, 108); Width: 406; Height: 864,
Session: SessionClient2; View: Surfaceview/textureview; Mviewposition: 2; Position:(418, 108); Width: 1232; Height: 864.

The data management module notifies the View management module of the above data information, and sets the display positions of the SurfaceView/TextureView corresponding to the first casting window and the second casting window respectively, so that the display effect of the multi-channel casting interface shown in FIG. 17 can be obtained.

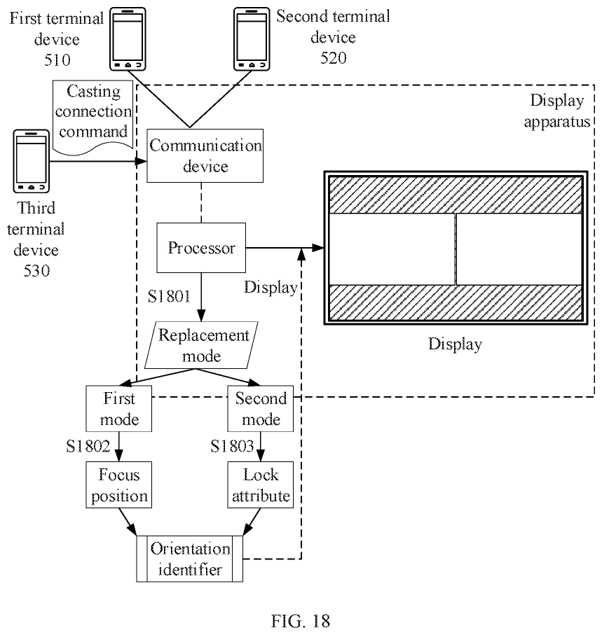

The display apparatus provided in the embodiments of the present disclosure can also detect a casting replacement mode in response to a casting connection command sent from a third terminal device. Based on that the casting replacement mode is a first mode, the display apparatus detects a focus position of a focus frame; removes a first replacement casting window at the focus position; and displays a third casting window according to an orientation identifier of the first replacement casting window. Based on that the casting replacement mode is a second mode, the display apparatus detects a lock attribute of the casting window; removes a second replacement casting window according to the lock attribute; and displays a third casting window according to an orientation identifier of the second replacement casting window. Herein, the second replacement casting window is a casting window whose lock attribute is in an unlocked state. Thus, according to different casting replacement modes, the casting window can be replaced through the window lock attribute or focus position, enabling the display apparatus to quickly switch the third casting window to a position desired by the user, and improving the user experience. Specifically, as shown in FIG. 18, it includes the following steps.

S1801: In response to a casting connection command sent from a third terminal device, a casting replacement mode is detected.

Due to the limitation of the screen resolution, the number of casting windows that the display apparatus can display simultaneously is limited. In some embodiments, the display apparatus can display at most a first casting window and a second casting window at the same time. Herein, the total number of the first casting window and the second casting window is the target number. Therefore, after the display apparatus has displayed the first casting window and the second casting window, when the display apparatus receives a casting connection command sent from a third terminal device 530, the display apparatus needs to replace the displayed first casting window or second casting window; and then detects the current casting replacement mode of the display apparatus.

For example, the target number is 2. In response to receiving a casting connection command sent from a terminal device 500, the display apparatus detects the number of terminal devices currently establishing a casting connection with the display apparatus. Based on that the number of terminal devices currently establishing a casting connection with the display apparatus is equal to 2, the display apparatus detects the casting replacement mode to replace the first casting window or the second casting window through the casting replacement mode. Based on that the number of terminal devices currently establishing a casting connection with the display apparatus is less than 2, the display apparatus sets the orientation identifier of the casting window corresponding to the terminal device according to the default priority order to display the casting window through the orientation identifier.

For ease of description, the embodiments of the present disclosure are described with the target number being 2, that is, the first casting window represents one casting window and the second casting window represents the other casting window; and the first terminal device 510 represents one terminal device and the second terminal device 520 represents the other terminal device.

Therefore, when the first casting window and the second casting window are already displayed in the multi-channel casting interface of the display apparatus, it indicates that the number of casting windows that the display apparatus can currently display has reached the maximum number. In this case, when the display apparatus receives a casting connection command sent from the third terminal device 530, the display apparatus detects the current casting replacement mode to execute different interaction procedures according to the detected casting replacement mode.

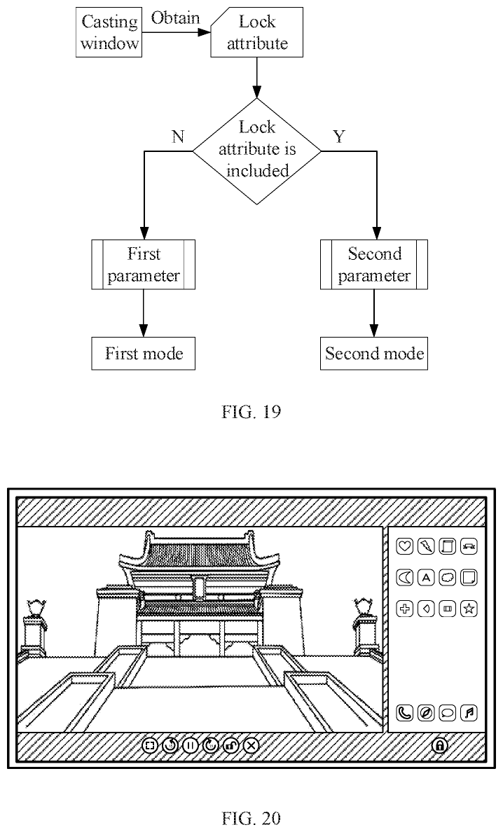

As shown in FIG. 19, the casting replacement mode of the display apparatus can be set based on the lock attribute of the casting window; that is, in some embodiments, the display apparatus also obtains the lock attribute of the casting window. The lock attribute includes a locked state and an unlocked state, and the locked state and the unlocked state correspond to different parameters. For example, the locked state of the lock attribute is lock; and the unlocked state is unlock. Based on that the lock attributes of the casting windows are all in the unlocked state, the display apparatus sets a replacement mode parameter to a first parameter. Based on that the lock attributes of the casting windows include the locked state, the display apparatus sets the replacement mode parameter to a second parameter. Herein, the first parameter is configured to represent that the casting replacement mode is the first mode; and the second parameter is configured to represent that the casting replacement mode is the second mode. The first mode queries the casting window to be replaced according to the focus position of the focus frame; and the second mode queries the casting window to be replaced according to the state of the lock attribute.

In some embodiments, when displaying the multi-channel casting interface, the display apparatus can also display playback function controls in the multi-channel casting interface; and the user can perform interactive operations through the playback function controls to input control commands and control the display apparatus to execute interactive responses. For example, the casting content of the display apparatus and the terminal device 500 is diverse, including mirrored video streams, pushed URL addresses, images, music and other different media asset types, and thus the playback function controls for different media asset types are also different. For example, video screen mirroring does not support fast forward and fast rewind operations, and also does not support play and pause operations; pushed URL addresses can support fast forward, fast rewind, play, pause and other operations; music can support fast forward, fast rewind, play, pause and other operations; and pictures do not support fast forward, fast rewind, play, pause, etc.

Since the lock attribute is an attribute that can be customized by the user, the playback function controls can also include a lock control. Therefore, in some embodiments, when displaying the casting window, the display apparatus also controls the display 260 to display a lock control in the casting window. Herein, the lock control is associated with the casting window. The lock control can be displayed in a floating manner above the casting window; or, as shown in FIG. 20, the lock control can also be displayed in an edge area such as above or below the casting window in the multi-channel casting interface.

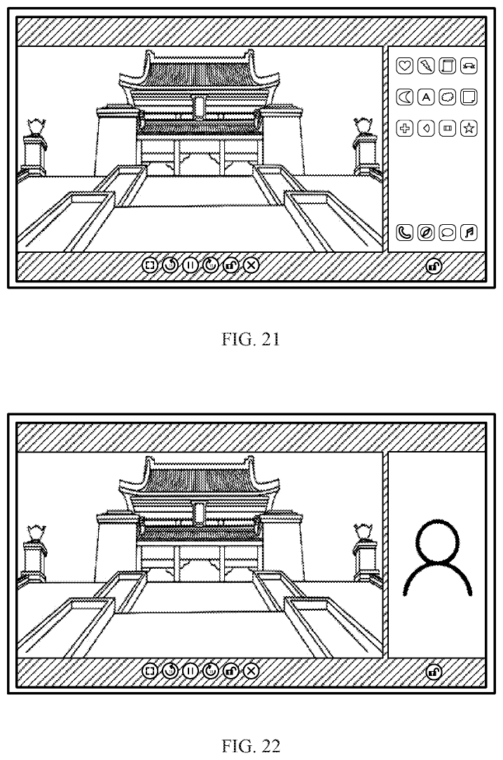

In some embodiments, when the user performs a selection operation on the lock control, the display apparatus automatically generates a selection command for the lock control; and refreshes the current value of the lock control and the lock attribute of the casting window in response to the selection command. After the display apparatus refreshes the current value of the lock control, the display content presented by the lock control will also change. For example, when the display apparatus displays the lock control as shown in FIG. 20, and the user performs a selection operation on the lock control on the right side, the display apparatus refreshes the lock attribute of the casting window to unlock and refreshes the current value of the lock control, so that the lock control presents the display content shown in FIG. 21.

S1802: Based on that the casting replacement mode is a first mode, a focus position of a focus frame is detected; a first replacement casting window at the focus position is removed; and a third casting window is displayed according to an orientation identifier of the first replacement casting window.

When the display apparatus detects that the casting replacement mode is the first mode, it indicates that the lock attributes of both the first casting window and the second casting window are in the unlocked state. In this case, the display apparatus detects the focus position of the focus frame and removes the first replacement casting window at the focus frame position. For example, if the focus position of the focus frame is on the first casting window, the first casting window is removed; if the focus position of the focus frame is on the second casting window, the second casting window is removed.

While removing the first replacement casting window, the display apparatus also creates a third casting window. Herein, the third casting window is configured to display the casting screen of the third terminal device 530; and the third casting window shares the same root node as the multi-channel casting interface. Then the display apparatus displays the third casting window according to the orientation identifier of the first replacement casting window. Therefore, if the casting replacement mode is the first mode, when the display apparatus displays the third casting window according to the orientation identifier of the first replacement casting window, the display apparatus can record the first orientation identifier of the first replacement casting window and create the third casting window. Then the display apparatus sets the orientation identifier of the third casting window to the first orientation identifier; and draws the third casting window according to the first orientation identifier.

That is, after the casting management module listens to the onConnect connection of the Session corresponding to the third terminal device Client3 through the UsessionConnectionListener, the casting management module invokes the Session. finish( ) interface to disconnect the Session corresponding to the casting window selected by the focus frame. For example, when the casting window selected by the focus frame is the second casting window, the casting management module notifies the View management module to perform a removal operation of rootview. removeView( ) on the View of Client2. At the same time, the View management module also stores the information of Client3 and creates the playback control SurfaceView/TextureView of the third casting window. After the SurfaceView/TextureView is successfully created, the display apparatus then sets the orientation identifier of Client3 to the orientation identifier of Client2 by starting the position management module, thereby replacing the position of the second casting window. Therefore, for the third terminal device, the data corresponding to Client3 can be expressed as: Session:SessionClient3; View:SurfaceView/TextureView; MViewPosition: 2.

For example, when the display apparatus establishes casting connections with the first terminal device 510 and the second terminal device 520, the display apparatus displays the multi-channel casting interface as shown in FIG. 21. Herein, the left side is the first casting window, the right side is the second casting window, and the lock attributes of both the first casting window and the second casting window are in the unlocked state. In this case, a casting connection command is sent to the display apparatus through the third terminal device 530; and the display apparatus detects the focus position of the focus frame according to the first mode. As shown in FIG. 21, the focus position is on the second casting window, that is, the second casting window is the first replacement casting window. The display apparatus then removes the second casting window and sets the orientation identifier of the third casting window to the orientation identifier of the second casting window, so that the third casting window replaces the position of the second casting window, presenting the multi-channel casting interface as shown in FIG. 22.

It can be understood that when the display apparatus replaces the first replacement casting window with the third casting window, the display apparatus can calculate the display area of the third casting window based on the algorithm provided in the above embodiments, which will not be repeated here.

Obviously, to facilitate the user to modify the lock attribute of the third casting window, the display apparatus will also generate a lock control associated with the third casting window after displaying the third casting window. Therefore, in some embodiments, the display apparatus also controls the display 260 to display a target lock control; and refreshes the current value of the lock control and the lock attribute of the third casting window in response to a selection command input from the user through the target lock control. Herein, the target lock control is associated with the third casting window.

S1803: Based on that the casting replacement mode is a second mode, the lock attribute of the casting window is detected; a second replacement casting window is removed according to the lock attribute; and the third casting window is displayed according to the orientation identifier of the second replacement casting window.

When the display apparatus detects that the casting replacement mode is the second mode, it indicates that the lock attribute of the first casting window and/or the second casting window is in the locked state. In this case, the display apparatus detects the lock attribute of each casting window and determines the second replacement casting window according to the lock attribute of each window. Herein, the second replacement casting window is a casting window whose lock attribute is in an unlocked state.

Since the lock attribute can be customized and modified by the user, the lock attributes of both the first casting window and the second casting window may be in the locked state. In this case, the display apparatus cannot replace any of the displayed casting windows with the third casting window. Therefore, in some embodiments, based on that the casting replacement mode is the second mode, the display apparatus traverses the lock attributes of the casting windows. Based on that the lock attributes of the casting windows do not include the unlocked state, the display apparatus controls the communication device to send a casting failure notification to the third terminal device, so that the third terminal device prompts the user with information about the casting failure.

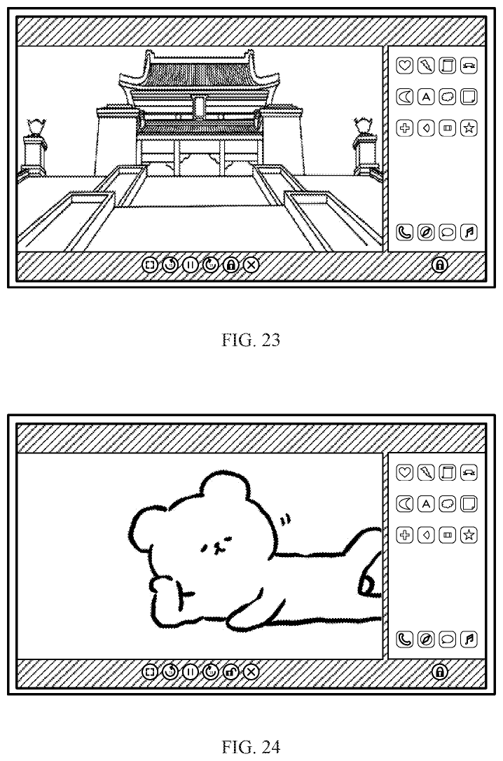

For example, the display apparatus can display the multi-channel casting interface as shown in FIG. 23. Herein, the left side is the first casting window, the right side is the second casting window, and the lock attributes of both the first casting window and the second casting window are in the locked state. In this case, after the casting management module listens to the onConnect connection of the Session corresponding to the third terminal device Client3 through the UsessionConnectionListener, the casting management module will not disconnect the first terminal device Client1 and the second terminal device Client2; the casting management module will not send any notification to the View management module; and the display apparatus will not create the view of Client3, but will notify Client3 that screen casting is not allowed in the current mode. After receiving this message, Client3 will prompt the user with information about the casting failure on the mobile terminal.

Based on that the lock attributes of the casting windows include one unlocked state, in some embodiments, when the display apparatus displays the third casting window according to the orientation identifier of the second replacement casting window, the display apparatus records the orientation identifier of the second replacement casting window. The second replacement casting window is a casting window whose lock attribute is in the unlocked state. The display apparatus creates a third casting window and sets the orientation identifier of the third casting window to the second orientation identifier; and then draws the third casting window according to the second orientation identifier.

That is, after the casting management module listens to the onconnect connection of the Session corresponding to the third terminal device Client3 through the UsessionConnectionListener, the casting management module performs index detection to find the unlocked casting window; and invokes the Session. finish( ) interface to disconnect the Session corresponding to the unlocked casting window. For example, when the unlocked casting window is the first casting window, the casting management module notifies the View management module to perform the removal operation of rootview. removeView( ) on the View of Client1. At the same time, the View management module also stores the information of Client3 and creates the playback control SurfaceView/TextureView of the third casting window. After the SurfaceView/TextureView is successfully created, the display apparatus then sets the orientation identifier of Client3 to the orientation identifier of Client1 by starting the position management module, thereby replacing the position of the first casting window. Therefore, for the third terminal device, the data corresponding to Client3 can be expressed as: Session: SessionClient3; View: SurfaceView/TextureView; MViewPosition: 1.

For example, when the display apparatus establishes casting connections with the first terminal device 510 and the second terminal device 520, the display apparatus displays the multi-channel casting interface as shown in FIG. 20. Herein, the left side is the first casting window, the right side is the second casting window, the first casting window is in the unlocked state, and the lock attribute of the second casting window is in the locked state. In this case, a casting connection command is sent to the display apparatus through the third terminal device 530; and the display apparatus detects the lock attributes of the casting windows according to the second mode. The first casting window whose lock attribute is in the unlocked state is the second replacement casting window. The display apparatus then removes the first casting window and sets the orientation identifier of the third casting window to the orientation identifier of the first casting window, so that the third casting window replaces the position of the first casting window, presenting the multi-channel casting interface as shown in FIG. 24.

It can be understood that the embodiments of the present disclosure are described with the target number being 2. In some application scenarios, if the target number set by the display apparatus is greater than 2, the lock attributes of the casting windows include the locked state, and the number of casting windows in the unlocked state is greater than 1, the display apparatus can mark the casting window in the unlocked state with the highest priority as the second replacement casting window according to the preset priority order, to replace the second replacement casting window with the third casting window.

In addition, when the display apparatus displays the first casting window and the second casting window, if the user disconnects the casting connection of one of the terminal devices, the casting window of the remaining terminal device may move. For example, when disconnecting the casting connection between the first terminal device 510 and the display apparatus, the display apparatus may remove the first casting window and display the guide window and the second casting window in the multi-channel casting interface. Since the display apparatus is provided with a default priority order, when the display apparatus recalculates the display area of each window, the display apparatus may set the orientation identifier of the second casting window to an orientation identifier with a higher priority, causing the second casting window to suddenly switch to the position of the first casting window. In this way, when the display apparatus displays multiple casting windows at the same time, if the casting connection of one of the terminal devices 500 is disconnected, the position of the casting window will switch back and forth, and the user's line of sight also needs to follow the position of the casting window to switch back and forth, affecting the user's viewing experience.

To improve the above problem of the casting window switching back and forth, in some embodiments, after displaying the third casting window, the display apparatus can also delete a target casting session in response to a casting termination command for the target casting session. Herein, the target casting session is a communication session generated based on the third terminal device. The display apparatus records the third orientation identifier of the third casting window; removes the third casting window; and calls the guide window. Herein, the guide window is configured to display the guide page, and the root node of the guide window is the same as the root node of the multi-channel casting interface. Then the display apparatus controls the display 260 to display the guide window according to the third orientation identifier.

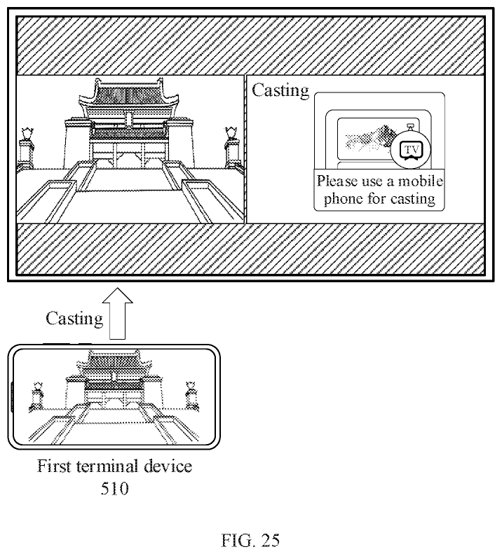

For example, the display apparatus has connected two Clients, namely the first terminal device Client1 and the third terminal device Client3. In the multi-channel casting interface as shown in FIG. 22 above, the left side is the first casting window of Client1, and the right side is the third casting window of Client3. The casting management service can listen to the onDisConnect( ) request of Client3 for disconnection through the UsessionConnectionListener; and notify the data management module to remove the Session of Client3. After the data management module successfully removes the information of Client3, the data management module synchronously notifies the View management module to make the View management module perform the removal operation of rootview. removeView( ) on the corresponding View. The data information of Client1 is retained, including: Session: SessionClient1; View: SurfaceView/TextureView; MViewPosition: 1. At the same time, the guide window on the right side can be re-called according to the orientation identifier of Client3, so that the multi-channel casting interface presents a display effect as shown in FIG. 25. In the display effect shown in FIG. 25, a size of the casting screen in the casting video stream corresponding to the first terminal device 510 (Client 1) is 1920×1080, and a display size of the guide page is 954×538. In this case, a ratio of the video stream and a ratio of a guide video stream on the right side are close to 16/9, and both are displayed in the same layout, for example, both are displayed in the landscape layout.

In some embodiments, the guide window also shares the same root with the multi-channel casting interface, that is, the root node of the guide window is the same as that of the multi-channel casting interface. When calling the guide window, the display apparatus can set the guide window to a display state; or re-call the relevant resources of the window object corresponding to the guide window.

To ensure the standardization of the layout of each window, when displaying the guide window, the display apparatus also calculates the display area of the guide window according to a resolution of the guide page. That is, in some embodiments, the display apparatus detects the screen resolution, the reference resolution, and the casting screen resolution. Herein, the reference resolution is the resolution of the guide page; and the casting screen resolution is a resolution of the casting screen in the multi-channel casting interface, that is, the casting screen corresponding to the terminal device 500 currently connected to the display apparatus. Then the display apparatus calculates a window layout parameter of the guide window according to the screen resolution, the reference resolution, and the casting screen resolution. Herein, the window layout parameter includes a layout width and a layout height.

After the display apparatus calculates the window layout parameter of the guide window, the display apparatus can display the guide window according to the window layout parameter. Therefore, in some embodiments, when the display apparatus displays the guide window according to a third orientation identifier, the display apparatus generates layout position coordinates of the guide window according to the window layout parameter and the third orientation identifier; records the window layout parameter and the layout position coordinates; and then draws the guide window according to the window layout parameter and the layout position coordinates.

For example, when the display apparatus displays the multi-channel casting interface as shown in FIG. 22 above, the left side is the first casting window of Client1, and the right side is the third casting window of Client3. In this case, the casting connection between Client3 and the display apparatus is disconnected; and the display apparatus deletes the Session of Client3 and removes the View corresponding to Client3. Then, based on the algorithm provided in the above embodiments, the display apparatus calculates the width and height of each window and the top-left corner coordinates of the window according to the screen resolution of the display apparatus, the casting screen resolution of the first casting screen, and the reference resolution of the guide window; and stores the above data information through the data management module. Then the data information is sent to the View management module, so that the View management module displays the display position of the casting SurfaceView/TextureView and the display position of the guide Layout through the setLayoutParams method, that is, the display effect as shown in FIG. 25 above can be obtained.

In some embodiments, when the multi-channel casting interface of the display apparatus includes only one casting window, that is, the display apparatus establishes a casting connection with only one terminal device 500, if the casting connection between the terminal device 500 and the display apparatus is disconnected, the display apparatus deletes the casting session of the terminal device and removes the casting window to display the default guide window. The default guide window can be as shown in FIG. 9 above.

For example, the screen resolution is 1920×1080, and the reference resolution of the guide page is 954×538. When the display apparatus displays the default guide window, the display apparatus calculates the window layout parameter and layout position coordinates based on the algorithm provided in the above embodiments. Herein, the data transmitted by the data transmission module includes: Session; View: layout; Position: (0, 271); Width: 954; Height: 538; Session; View; Position: (966, 271); Width: 954; Height: 538. The View management module displays the display position of the guide Layout through the setLayoutParams method, that is, the display effect as shown in FIG. 9 above can be obtained.

As mentioned earlier, since the terminal device 500 may be in different placement states according to different usage modes. For example, for a terminal device 500 such as a smartphone, it may be in a portrait state or a landscape state during use. When the display apparatus displays casting screens of multiple terminal devices 500 in an area division manner, display areas will present different image ratios due to different placement states of the terminal devices 500. For example, the first terminal device 510 is in a landscape state, and a size of the first casting screen is 1920×1080; and the second terminal device 520 is in a portrait state, and a size of the second casting screen is 512×1088. Then the first casting window can be 954×538, and the second casting window can be 508×1080.

To make full use of the display space of the multi-channel casting interface and reduce large-area black screen areas, in some embodiments, when sizes of the first casting screen and the second casting screen are inconsistent, the display apparatus can also set the width or height of the first casting window and the second casting window to be consistent, and scale the casting windows according to the width or height.

For example, when the first terminal device 510 is in a portrait state and the size of the first casting screen is 512×1088, the second terminal device 520 is in a landscape state and the size of the second casting screen is 1920×1080, and the resolution of the display of the display apparatus is 1920×1080, the default size of the first casting window and the second casting window (that is, a display size of the guide page) is 954×538. In this case, the ratio and direction of the video stream are different from those of the right guide video stream. Through algorithm calculation, the display height of the left video stream is about 848 and the display width of the left video stream is about 400. Excluding the blank area, the remaining width is the width of the guide page, and the height is consistent with that of the video stream.

The display apparatus can dynamically adjust the playback function controls according to the display area of the casting window in the multi-channel casting interface, so that the display position of the playback function controls is adapted to the casting window, facilitating the user to perform interactive operations. For example, the playback function controls belonging to the same casting window can form a playback control list. The playback control list includes several button controls such as fullscreen, fast forward, fast rewind, play/pause, mute/unmute, and close. A size of each button control is 60×60, and a horizontal spacing between button controls is 24. Combined with the left and right margins of the playback control list, the minimum display width for displaying six button controls is 528, the minimum display width for displaying three button controls is 276, the minimum display width for displaying two button controls is 192, the minimum display width for displaying one button control is 108, and the same logic applies to other numbers of button controls.

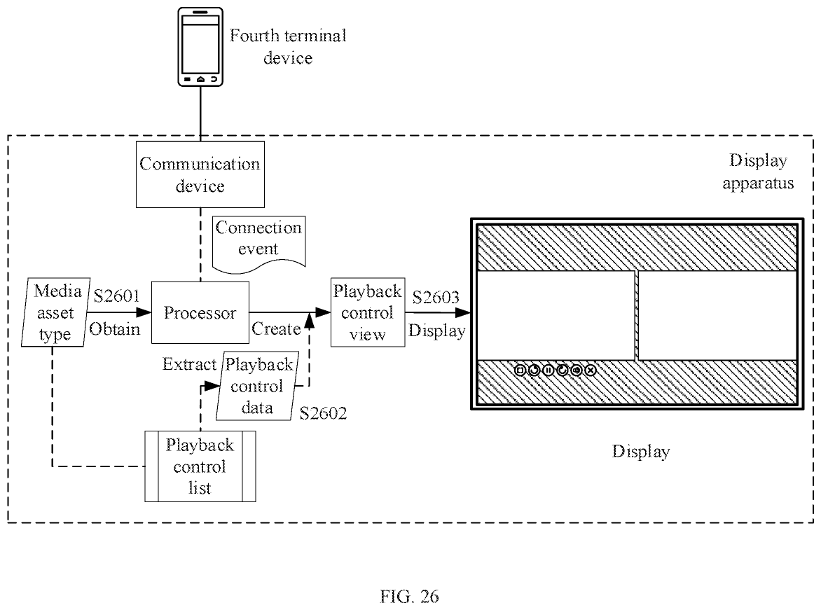

Due to the diversity of casting content between the display apparatus and terminal devices, the displayed playback function controls may be incompatible with the casting content, reducing user experience. Based on this, the display apparatus provided in the embodiments of the present disclosure can also obtain a media asset type of casting screen data in response to a connection event for establishing a casting connection between the display apparatus and a fourth terminal device; extract playback control data associated with the media asset type from a playback control list, and create a playback control view according to the playback control data; set a display position of the playback control view according to the display area of the casting window; and finally control the display to display the playback control view at the display position. Herein, the playback control list includes playback control data preset for the playback control views, and the playback control view is a control in the casting interface for performing playback control on the casting screen data. Through the above process, the display apparatus can dynamically adjust the display of playback function controls according to the media asset type and the casting display area, improving user experience. Specifically, as shown in FIG. 26, it includes the following steps.

S2601: A media asset type of casting screen data is obtained in response to a connection event for establishing a casting connection between the display apparatus and a fourth terminal device.

S2602: Playback control data associated with the media asset type is extracted from a playback control list and a playback control view is created according to the playback control data. The playback control list includes playback control data preset for the playback control views, and the playback control view is a control in the casting interface for performing playback control on the casting screen data.

To facilitate the processing of playback control data, the display apparatus can generate a playback control sublist according to the playback control data associated with the media asset type in the playback control list, and create a playback control view according to the playback control sublist. When subsequent relevant logical processing is performed on the playback control view, only the playback control data in the playback control sublist needs to be processed. That is, the playback control list is a total list containing playback control data of all types of playback control views, and the playback control sublist is a sublist containing playback control data of the playback control view related to the current casting connection of the fourth terminal device.

The generation of the playback control sublist can include multiple methods. After obtaining the media asset type of the casting screen data, the display apparatus calls the playback control list, copies the playback control list, and deletes the playback control data not associated with the media asset type from the playback control list to generate the playback control sublist. The display apparatus can also create a playback control sublist and add the playback control data associated with the media asset type in the playback control list to the playback control sublist.

For example, after the casting management module listens to the onConnect connection of a new Session through the UsessionConnectionListener, the casting management module can obtain a media asset type of the currently connected terminal device (i.e., the fourth terminal device Client4) from the Session, such as VIDEO_URL (video URL), MIRROR_STREAM (mirrored stream), MUSIC (music), PIC (picture), etc. For example, if the display apparatus currently displays media asset data obtained based on the VIDEO_URL address pushed by the fourth terminal device, operations such as fullscreen, fast forward, fast rewind, play/pause, mute/unmute and close can be performed on the display apparatus.

In this case, playback control data can be added to this Session. For example, the playback control sublist includes 6 playback function controls associated with the media asset type, such as 6 button controls. The data format corresponding to these button controls can be expressed as: Fullscreen button control: DoublePushControlBean[mStatus=true, mType=fullscreen, mResId=2131231132]; Fast rewind button control: DoublePushControlBean[mStatus=true, mType=rewind, mResId=2131231110]; Play button control: DoublePushControlBean[mStatus=true, mType=playstatus, mResId=2131231149]; Fast forward button control: DoublePushControlBean[mStatus=true, mType=forward, mResId=2131231111]; Mute button control: DoublePushControlBean[mStatus=true, mType=mutestatus, mResId=2131231152]; Close button control: DoublePushControlBean[mStatus=true, mType=close, mResId=2131231121].

In this way, the display apparatus can create and display playback function controls related to the media asset type of the current Client4 according to the above playback control sublist, facilitating the user to perform interactive operations.

S2603: A display position of the playback control view is set according to a display area of the casting window and the display is controlled to display the playback control view at the display position.

In some embodiments, during multi-channel screen casting, to facilitate the user to distinguish the playback function controls corresponding to each casting channel, the display apparatus can dynamically adjust the playback function controls according to the display area of the casting window in the multi-channel casting interface, so that the display position of the playback function controls is adapted to the display area of the casting window. That is, the display apparatus can set the display position of the playback control view according to the display area of the casting window and control the display to display the playback control view at the display position.

A view size of the playback control view can be preset according to actual needs. For example, the playback control list includes playback function controls such as fullscreen, fast forward, fast rewind, play/pause, mute/unmute, and close. A size of each playback function control can be set to 60×60, and a horizontal spacing between playback function controls is 24. Combined with the left and right margins of the playback control list, the minimum display width for displaying six playback function controls is 528, the minimum display width for displaying three playback function controls is 276, the minimum display width for displaying two playback function controls is 192, the minimum display width for displaying one playback function control is 108, and the same logic applies to other numbers of button controls.

To improve the display effect, the playback control views can be displayed in the horizontal/vertical arrangement. The display apparatus can plan the display position of the playback control views according to the display area of the casting window, and can also calculate the maximum display number of playback control views that can be displayed in the horizontal/vertical arrangement according to a size of the display area of the casting window and a preset view size of the playback control view. Therefore, the display apparatus can obtain the area size of the display area of the casting window and the preset view size of the playback control view; calculate the display number of playback control views according to the area size and the view size; and extract the playback control data associated with the media asset type from the playback control list according to the display number.

When the playback function controls are displayed horizontally, the display apparatus can obtain an area width of the display area of the casting window and a total width of the playback control bar. Herein, the playback control bar is obtained by arranging the playback control views associated with the media asset type according to a preset spacing. The area width of the display area of the casting window is compared with the total width of the playback control bar. Based on that the area width is greater than or equal to the total width, it means that all playback control views associated with the media asset type can be displayed in the horizontal mode. Then the subsequent steps of extracting the playback control data associated with the media asset type from the playback control list and creating and displaying the playback control views according to the playback control data are performed.

Based on that the area width is smaller than the total width, it means that not all playback control views associated with the media asset type can be displayed in the horizontal mode. Then the display number of playback control views that can be displayed is calculated according to the area width and the total width; the playback control data associated with the media asset type is extracted from the playback control list according to the display number; and the playback control views of the display number are created and displayed according to the playback control data.

It can be understood that when the playback function controls are displayed horizontally, the maximum display number of playback control views that can be displayed in the horizontal arrangement can be calculated based on the area width of the display area of the casting window. When the playback function controls are displayed vertically, the maximum display number of playback control views that can be displayed in the vertical arrangement can also be calculated based on an area height of the display area of the casting window.

It should be noted that the display method of the playback function controls provided in the above embodiments is only an example. The playback function controls of the display apparatus are not limited to being displayed in the above horizontal/vertical arrangement, and can also be displayed in other forms. For example, they may be arranged and displayed in a rectangular array or a circular array, or displayed through edge sliding. However, the basic display principle is universal.

In some embodiments, to meet the actual needs of users, weight values can be set for the playback control views in the playback control list. When the display apparatus extracts the playback control data associated with the media asset type from the playback control list according to the display number, the display apparatus can traverse weight values of the playback control data in the playback control list; sort the playback control data in the playback control list in a descending order of the weight values; and extract the first k pieces of playback control data associated with the media asset type from the sorted playback control list; herein, k is the display number, and k is greater than or equal to 0.

That is, priorities for the playback control views in the playback control list are set based on the weight values. When not all playback control views can be displayed, the playback control views with higher weight values are selected and displayed according to the weight values. For example, in a descending order of weight values, the playback control views in the playback control list are sorted as follows: fullscreen, close, mute/unmute, play/pause, fast forward, fast rewind. When only 3 playback control views can be displayed, the fullscreen, close and mute/unmute playback control views can be displayed.

For example, taking the above media asset type as the pushed VIDEO_URL address as an example, to display the above playback function controls, after the data management module obtains a display size of the casting window, the View management module performs layout and display to achieve the display effect as shown in FIG. 27. The left casting window displays the media asset image obtained based on the pushed URL address, and supports playback controls such as fullscreen, fast forward, fast rewind, play/pause, mute/unmute, close, etc. Through an algorithm processing module, it can be calculated that a size of the left casting window is 1508×848, and a size of the right casting window is 400×848.

After calculating the window display positions of the left and right casting windows, the View management module may perform layout and display of the left and right casting windows. At the same time, the View management module also initializes and displays the playback control views according to the playback control sublist data of the Session. For example, the display apparatus can use the RecycleView control to display the playback control views, set the display parameter of the RecycleView control through LayoutParams (including the position relative to the top boundary and left boundary, i.e., coordinates, as well as the corresponding display width and height), and then display the position through the setLayoutParams method.

Regarding the display number of the playback control views when displayed horizontally, after calculation by the algorithm processing module, the display area width of 1508 of the left casting window is greater than the total width of 528 of the playback control bar when displaying six playback function controls, indicating that all playback function controls can be displayed. Therefore, the playback control views created and displayed according to the playback control list data of the Session presents the display effect as shown in FIG. 27, with six playback function buttons displayed centered below the left casting window. Of course, playback function buttons can also be displayed at any other position.

After the display apparatus displays the playback control views, the user can input a control command based on the playback control views to control the display apparatus to execute interactive responses. The display apparatus can obtain a playback control type of a target playback control view from the playback control list in response to a click command for the target playback control view; invoke a processing interface associated with the playback control type; and perform the processing operation associated with the target playback control view on the casting screen data based on the processing interface.

For example, for the playback function buttons shown in FIG. 27, the user can use direction keys on the remote control adapted to the display apparatus to control a focus cursor to move to the “play” playback function button, and press the “confirm” key on the remote control to input a pause command. In this case, RecycleView will listen to the user's onClick operation, identify an index type of the playback control list (i.e., the mType is playstatus), and then invoke the setPlayerPause( ) interface of the Session to perform pause playback processing. Similarly, for fast forward and fast rewind operations, the setPlayerSeekBackward( ) and setPlayerSeekForward( ) of the Session can also be invoked for corresponding playback control processing.

In some embodiments, when the display area of the casting window changes, the playback function controls also need to be dynamically adjusted according to the display area of the casting window. That is, the display apparatus can obtain a changed display area in response to a change notification of the display area of the casting window; reset a display position of the playback control views according to the changed display area; and recalculate the display number of playback control views according to an area size of the changed display area.

In this regard, the casting management module can monitor the state of the casting session. When the Video changes, the casting management module notifies the algorithm processing module through the message processing module. The algorithm processing module calculates the casting display area, and then informs the data management module through the message processing module. After the data management module conducts data collation, the data management module notifies the View management module through the message processing module to redraw and display the View.

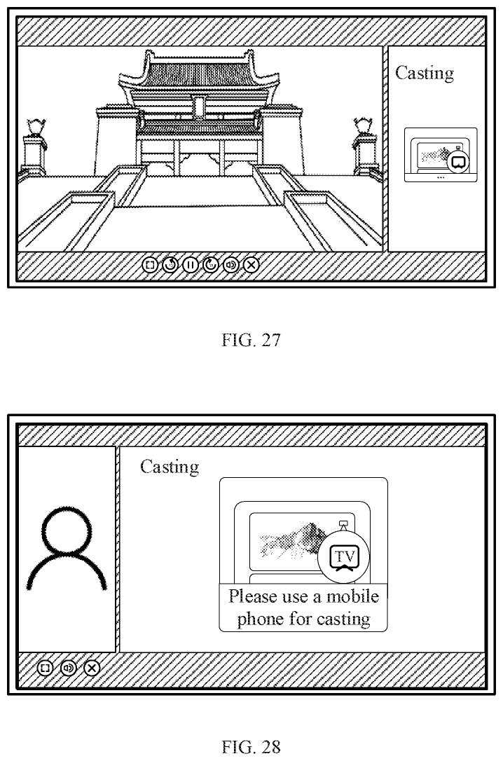

For example, when the above media asset content of VIDEO_URL type changes or the direction of the video stream changes, the display apparatus can re-layout the display of the casting content to present the display effect as shown in FIG. 28, where the left casting window displays the media asset image of VIDEO_URL type. Through the algorithm processing module, it can be calculated that the size of the left casting window is 459×816, and the size of the right casting window is 1449×816.

Regarding the display number of the playback control views when displayed horizontally, after calculation by the algorithm processing module, the display area width of 459 of the left casting window is smaller than the total width of 528 of the playback control bar when displaying six playback function controls, but larger than the total width of 276 of the playback control bar when displaying three playback function controls, indicating that three playback function controls can be displayed. Therefore, three playback function controls including fullscreen, mute/unmute and close can be displayed, and their data formats are as follows: DoublePushControlBean[mStatus=true, mType=fullscreen, mResId=2131231132]; DoublePushControlBean[mStatus=true, mType=mutestatus, mResId=2131231152]; DoublePushControlBean[mStatus=true, mType=close, mResId=2131231121].

The View management module can notify RecycleView to refresh the View through the Adapter's notifyDataSetChanged method according to the above playback control data, changing from 6 playback function controls to 3 playback function controls, presenting the display effect as shown in FIG. 28, with three playback function buttons displayed centered below the left casting window. It can be seen that in the above embodiments, when the width of the casting window cannot meet the arrangement of six playback function controls, the display apparatus can adjust the number of playback function controls from six to three for display.

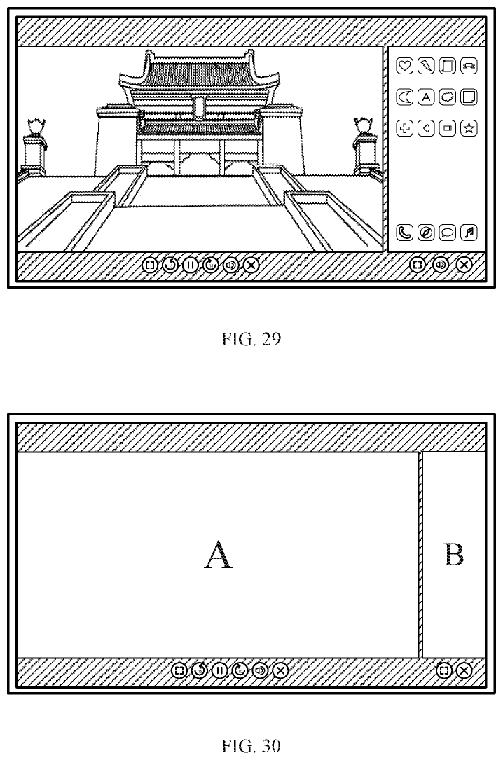

Similarly, after the casting management module listens to the onConnect connection of a new Session through the UsessionConnectionListener, the casting management module can obtain from the Session that the media asset type of the current Client4 is MIRROR_STREAM. The View management module performs layout and display to achieve the display effect as shown in FIG. 29, where the right casting window displays the mirrored media asset image, on which the fullscreen, mute/unmute and close operations can be performed on the display apparatus. In this case, playback control data can be added to this Session, and the data formats are as follows: DoublePushControlBean[mStatus=true, mType=fullscreen, mResId=2131231132]; DoublePushControlBean[mStatus=true, mType=mutestatus, mResId=2131231152]; DoublePushControlBean[mStatus=true, mType=close, mResId=2131231121].

Through the algorithm processing module, it can be calculated that the size of the right casting window is 400×848, that is, the following data result is obtained: Session: SessionClient4,View: SurfaceView/TextureView, MViewPosition: 2,Position: (1520,116), Width: 400,Height: 848,mDoublePushControlListBean: . . .

The algorithm processing module calculates the casting display area, and then informs the data management module through the message processing module. According to data of the data management module, the size of the right casting window is 400×848, and the size of three playback function controls is 276. Since the display area width of 400 of the right casting window is greater than the total width of 276 occupied by three playback function controls, three playback function buttons can be fully displayed.

The View management module can perform initialization and display processing of RecycleView, set display parameters through LayoutParams (including the position relative to the top boundary and left boundary, i.e., coordinates, as well as the corresponding display width and height), and then display the position through the setLayoutParams method to present the display effect as shown in FIG. 29, with three playback function buttons displayed centered below the right casting window.

When the width of the casting window cannot meet three button controls, the number of playback control buttons can be further adjusted according to the display area width of the casting window. For example, taking the display effect shown in FIG. 30 as an example, if the size of the right casting window is 258×864, the display area width of 258 of the right casting window is smaller than the total width of 276 when displaying three playback function controls, and larger than the total width of 192 when displaying two playback function controls. Therefore, the display apparatus can display two playback function controls below the right casting window. Moreover, since the volume can be controlled in a mutually exclusive manner through the playback function controls of the left casting window, only two playback function controls, namely fullscreen and close, can be retained, that is, the corresponding playback control list data is: DoublePushControlBean[mStatus=true, mType=fullscreen, mResId=2131231132]; DoublePushControlBean[mStatus=true, mType=close, mResId=2131231121].

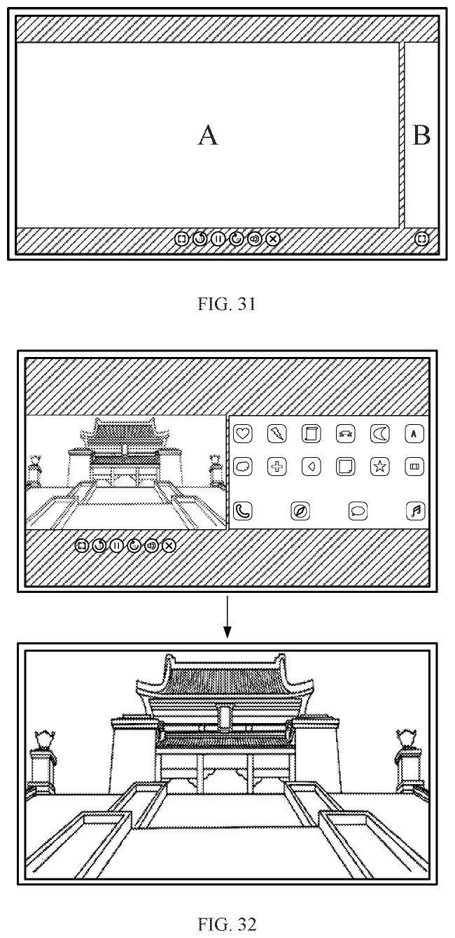

Similarly, taking the display effect shown in FIG. 31 as an example, if the size of the right casting window is 156×864, the display area width of 156 of the right casting window is smaller than the total width of 192 when displaying two playback function controls, and larger than the total width of 108 when displaying one playback function control. Therefore, the display apparatus can display one playback function control below the right casting window. Since closing the casting window can be controlled by stopping the casting operation on the fourth terminal device, only the fullscreen button can be retained, that is, the corresponding playback control list data is: DoublePushControlBean[mStatus=true, mType=fullscreen, mResId=2131231132].

By analogy, if the size of the right window is 88×864, the display area width of 88 of the right casting window is smaller than the total width of 108 when displaying one playback function control, so the button control cannot be displayed. Therefore, the display apparatus can cancel the display of the playback function control below the right casting window.

In the above process, in view of the diversity of casting content between the display apparatus and the fourth terminal device, the playback function control(s) adapted to the casting content of the fourth terminal device is displayed. For different media asset types such as mirrored video streams, pushed URL addresses, pictures and music, different playback function controls are displayed correspondingly, thereby reducing the occurrence of errors in playback control operations input by users, and enabling users to intuitively distinguish different casting types during multi-channel screen casting. For example, video screen mirroring does not support fast forward and fast rewind operations, and also does not support play and pause operations, so the playback function controls for fast forward, fast rewind, play and pause are not displayed; pushed URL addresses can support operations such as fast forward, fast rewind, play and pause, so the playback function controls for fast forward, fast rewind, play, and pause are displayed; music can support operations such as fast forward, fast rewind, play and pause, so the playback function controls for fast forward, fast rewind, play and pause are displayed; and pictures do not support operations such as fast forward, fast rewind, play and pause, so the playback function controls for fast forward, fast rewind, play and pause are not displayed. Thus, the display of playback function controls is dynamically adjusted according to the media asset type and casting display area, improving user experience.

As mentioned earlier, in the multi-channel casting scenario, the display apparatus can only display the casting screen of a single terminal device. If the display apparatus establishes connections with multiple terminal devices (such as the aforementioned first terminal device and second terminal device) at the same time, when the user wants to switch between multiple casting channels, it is necessary to frequently switch signal sources of screen casting; and during each switching process, the casting connection needs to be re-established, resulting in a long waiting time for the switching process, which is not conducive to fast switching and reduces user experience.

In some embodiments, the user can input a control command based on the button control on the multi-channel casting interface to control the display apparatus to perform interface switching. For example, as shown in FIG. 32, when the user clicks the fullscreen button below the first casting window, the display apparatus can switch from the multi-channel casting interface to the full-screen display of the casting screen in the first casting window, that is, the casting screen of the first terminal device 510 is displayed. Since the display apparatus will no longer display the casting screen corresponding to the second casting window after switching to the full-screen display of the casting screen of the first casting window, the display apparatus can close the casting screen data transmission channel corresponding to the second casting window, that is, terminate the casting connection with the second terminal device 520.

However, after the display apparatus switches to the state of the full-screen display of the casting screen in one casting window, the user may also need to switch back to the multi-channel casting interface as required. For example, after controlling the display apparatus to display the casting screen corresponding to the first casting window in the full screen, if the user wants to view the casting screen in the second casting window, the user can press the “back” key on the matching remote control of the display apparatus to control the display apparatus to switch back to the multi-channel casting interface. In this case, since the display apparatus has terminated the casting connection with the second terminal device 520, the display apparatus needs to re-establish the casting connection and obtain the casting screen data sent by the second terminal device 520 to display the corresponding casting screen through the second casting window in the multi-channel casting interface.

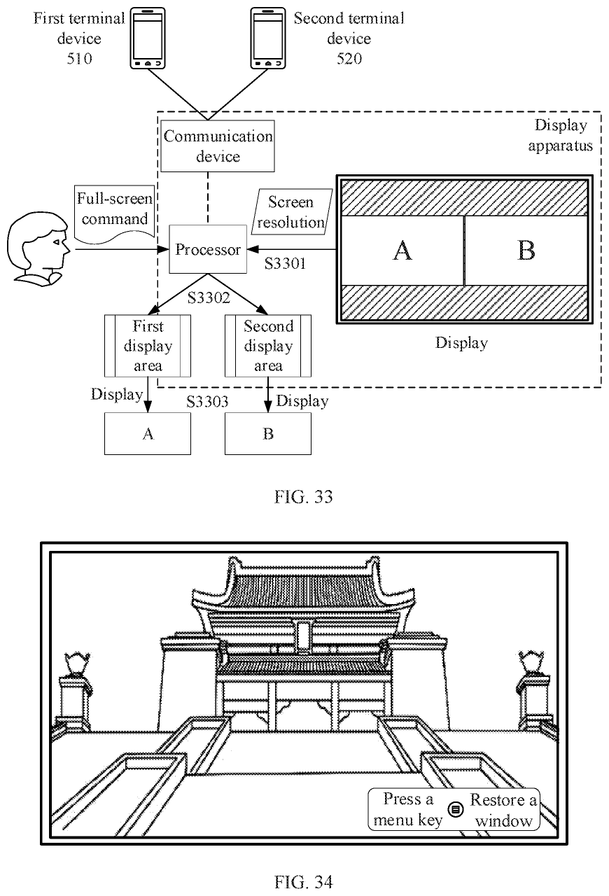

Based on this, when displaying the multi-channel casting interface, the display apparatus provided in the embodiments of the present disclosure can also obtain a screen resolution of the display in response to a full-screen command for the full-screen display of the first casting window; and set a first target display area of the first casting window and a second target display area of the second casting window according to the screen resolution; herein the number of pixels in the second target display area is less than or equal to a preset pixel threshold. So that the first casting screen is displayed through the first target display area; and the second casting screen is displayed through the second target display area. Thus, when displaying the first casting window in the full screen, the second casting window is not directly closed. Instead, the second casting screen is displayed using a small number of pixels that are imperceptible to the user by setting the second target display area, enabling the display apparatus to freely and quickly switch between the full-screen and multi-window casting interface according to usage scenarios and improving user experience. Specifically, as shown in FIG. 33, it includes the following steps:

S3301: In response to a full-screen command for the full-screen display of the first casting window, the screen resolution is obtained.

When the display apparatus displays the multi-channel casting interface, the user can input a full-screen command by clicking a button control in the multi-channel casting interface. For example, if the first casting window is a left window in the multi-channel casting interface, when displaying the multi-channel casting interface, the display apparatus can display a “fullscreen” button control below the first casting window according to the process for displaying the button control provided in the above embodiments. If the user wants to display the left window in the full screen and temporarily stop viewing the right window, the user can perform an interactive operation through the fullscreen button control below the left window, and the user can use the direction keys on the remote control to move a focus cursor to the “fullscreen” button control and press the “confirm” key on the remote control to input the full-screen command.

In this regard, the RecycleView component of the playback control bar in the display apparatus may monitor the user's operations in real time. After detecting that the operation type mType triggered by the user is the fullscreen operation type and the user triggers an OnClick event, the selected casting screen may be displayed in the full screen by modifying DoublePushControlBean[mStatus=true, mType=fullscreen, mResId=2131231132].

The user can also input the full-screen command in other ways. For example, when the focus cursor selects the first casting window, the user can long-press the “confirm” key to control the display apparatus to display the casting screen corresponding to the first casting window in the full screen, i.e., input the full-screen command by long-pressing the confirm key. For display apparatuses supporting touch interaction, the user can directly click the “fullscreen” button control through touch to input the full-screen command. For display apparatuses supporting voice interaction, the user can input the full-screen command by speaking the voice command “full-screen display of the left window”.

In some embodiments, the full-screen command can also be automatically input by the display apparatus through determining the display scenario. For example, when displaying the multi-channel casting interface, the display apparatus can record a display duration of the casting screen in each casting window. When the duration of displaying the specific casting screen in the first casting window exceeds a preset duration threshold and no specific casting screen is displayed in the second casting window (a guide interface is displayed), the display apparatus can automatically generate a full-screen command and automatically display the first casting window in the full screen.

After obtaining the full-screen command for the full-screen display of the first casting window, the display apparatus can obtain the screen resolution in response to the full-screen command. The screen resolution can be the resolution of the display or the resolution of an effective display area in the user interface. For example, for a display apparatus where the entire screen is the effective display area, the display apparatus can directly the screen resolution of the display, which is 1920×1080, after obtaining the full-screen command. For a special-shaped screen with a camera module at the top, if the total resolution of the display is 1920×1180 and a height occupied by the camera module is 100, the display apparatus can obtain the screen resolution of the effective display area after removing the 100-pixel camera module area after obtaining the full-screen command, i.e., 1920×1080.

It should be noted that the first casting window and the second casting window described in the embodiments of the present disclosure are only used to distinguish different casting windows, and an example is given where the first casting window is located on the left side of the multi-channel casting interface and the second casting window is located on the right side of the multi-channel casting interface. It should be understood that the first casting window and the second casting window do not limit the specific display positions of the casting windows in the multi-channel casting interface. The first casting window only represents a window for which full-screen display of the casting screen is required, and the second casting window only represents a window for which full-screen display of the casting screen is not required. Therefore, the first casting window can also refer to the window on the right side of the multi-channel casting interface, and the second casting window can also refer to the window on the left side of the multi-channel casting interface.

In some embodiments, to indicate the window for full-screen image display, the display apparatus can also set a conversion mode parameter for the window. That is, the display apparatus can set a conversion mode parameter of the first casting window to a first parameter value and a conversion mode parameter of the second casting window to a second parameter value in response to a full-screen command for displaying the first casting window in the full screen. Herein, the first parameter value represents full-screen display of the casting window; and the second parameter value represents hiding the casting window.

For example, when switching between the dual-channel casting mode and full-screen mode, a mode management module of the display apparatus can set a SwitchMode attribute. When the SwitchMode is the full-screen mode, the parameter is a first parameter value full; when the SwitchMode is the hidden mode, the parameter is a second parameter value Hidden; when the SwitchMode is the dual-channel casting window mode, the parameter is a third parameter value double, thereby indicating various logics and display processes during switching.

S3302: The first target display area of the first casting window is set and the second target display area of the second casting window is set according to the screen resolution.

After obtaining the screen resolution, the display apparatus can display the casting screen of the first casting window in the full screen. However, since the screen resolution of the display apparatus is inconsistent with the size of the casting screen corresponding to the first casting window, the display apparatus needs to display the casting screen of the first casting window according to the screen resolution.

In some embodiments, when setting the first target display area, the display apparatus can obtain the casting screen resolution of the first casting screen; read a screen width and a screen height from the screen resolution; determine a reference size according to the screen resolution and the casting screen resolution, where the reference size is the screen width or screen height; calculate a scaling ratio based on the reference size; and scale the first casting screen according to the scaling ratio.

For example, a video stream size of the first terminal device is 512×1088, the screen resolution of the display apparatus is 1920×1080, and the display size of the guide page is 954×538. In this case, the ratio and direction of the video stream are different from the ratio and direction of the right guide video stream. The reference size can be set according to the video height. Considering the page layout and the ratio of the right window, the display height of the left video stream can be set to 848, and the scaling ratio is calculated according to the display height of 848 and the original video height, i.e., 848/1088. The display width is then calculated according to this scaling ratio, i.e., 512×848/1088=399.

To improve a switching speed when the display apparatus switches from the full-screen display of the first casting screen back to displaying the multi-channel casting interface, the display apparatus can temporarily not close the second casting window while displaying the first casting screen in the full screen, but hide the casting window instead. Therefore, the display apparatus can set the first target display area of the first casting window according to the screen resolution to achieve the effect of the full-screen display of the first casting screen, and set the second target display area of the second casting window at the same time. Herein, the second target display area can complete image display with fewer pixels, making the second casting screen imperceptible to the user. Thus, the number of pixels in the second target display area is less than or equal to a preset pixel threshold. The preset pixel threshold is the maximum number of pixels that cannot be distinguished by the user at a preset viewing distance when the display apparatus displays an image. For example, for display apparatuses such as televisions, the user's viewing distance is 1-3m, and an image with fewer than 4 pixels will not be perceived by the user at this viewing distance, so the preset pixel threshold is 4.

In some embodiments, when calculating the second target display area, the display apparatus can determine a boundary area according to the first target display area, where the boundary area is an area in the entire display area of the display except the first target display area, or an area formed by edge pixels of the first target display area; set the minimum number of pixels of the second target display area according to the preset pixel threshold; and delineate the second target display area in the boundary area according to the minimum number of pixels.

For example, the display apparatus sets the first target display area to 1920×1080 and the second target display area to 1×1. The first target display area can realize the full-screen display of the first casting screen. At the same time, the second casting screen is displayed through one pixel, which will not affect the display of the first casting screen. The one pixel for displaying the second casting screen can be set in an area that is not easily perceived by the user, such as the top-left corner, top-right corner, bottom-left corner, or bottom-right corner of the display.

S3303: The display is controlled to display the first casting screen in the first target display area and the second casting screen in the second target display area.

After setting the first target display area and the second target display area, the display apparatus can display the first casting screen and the second casting screen through the first target display area and the second target display area respectively. The first target display area includes more pixels, for example, the first target display area can be the entire display screen area or a large-proportion central display area, thereby achieving the effect of the full-screen display of the first casting screen. The second target display area includes fewer pixels, for example, one pixel or two pixels, thereby achieving the effect of hiding the second casting screen.

For example, the size of the casting screen in the casting video stream from the first terminal device 510 is 1920×1080. According to the interface switching display method provided in the above embodiments, the first target display area can be determined as 1920×1080, and the second target display area can be determined as 1×1. In this case, the second terminal device can be ignored, and a window of the first target display area defaults to the entire screen size of 1920×1080. The full-screen first target display area is calculated according to a video stream ratio ratio1 and a ratio of the entire screen ratio_fullscreen. Then, combined with the landscape or portrait mode of Client1, it is determined that the current video ratio is consistent with the screen ratio.

Therefore, the display area size of the first target display area shall be 1920×1080, that is: Session: SessionClient1,View: SurfaceView/TextureView, MViewPosition:−1,Position: (0,0), Width:1920,Height:1080,SwitchMode:full . . . Based on the same logic, a size of the second target display area is: Session:SessionClient2,View:SurfaceView/TextureView, MViewPosition:−1,Position: (0,0), Width:1,Height:1,SwitchMode: Hidden . . .

Since the first target display area is displayed in the full screen, when the second target display area is displayed through one pixel, the display position can be at any corner without affecting the user's viewing. For example, the display position Position of the second casting window can be (0,0), (1919,0), (0,1079), (1919,1079), etc.

After setting the coordinates, width and height of the first target display area and the second target display area, the algorithm processing module notifies the data management module to conduct data collation through the message processing module, and then notifies the View management module. After receiving the data information, the View management module sets display parameters through LayoutParams (including the position coordinates relative to the top boundary and left boundary of the display, and the corresponding display width and height); and then displays positions of two target display areas through the setLayoutParams method.

For the first casting window: FrameLayout.LayoutParams lp1=new FrameLayout.LayoutParams(width, height, 0); lp1.width=1920; lp1.height=1080; lp1.leftMargin=0; lp1.topMargin=0; mPlayerView.setLayoutParams(lp 1).

For the second casting window: FrameLayout.LayoutParams lp1=new FrameLayout.LayoutParams(width, height, 0); lp1.width =1; lp1.height=1; lp1.leftMargin=0; lp1.topMargin=0; mPlayerView.setLayoutParams(lp1).

In the above process, after obtaining the full-screen command, the display apparatus can obtain the screen resolution, set the first target display area according to the screen resolution to achieve the display effect of the full-screen display of the first casting screen, and meanwhile, set the second target display area with the number of pixel(s) less than the preset pixel threshold to display the second casting screen with fewer pixel(s) to achieve the effect of hiding the second casting screen. Then, the first casting screen and the second casting screen are displayed based on the first target display area and the second target display area respectively, achieving the purpose that one casting screen is displayed in the full screen and the other casting screen is processed in a hidden manner. After switching to the full-screen state, the casting connection between the display apparatus and the second terminal device 520 is not closed. When switching back to the multi-channel casting interface, there is no need to re-establish the casting connection, and the multi-channel casting interface can be quickly presented.

In some embodiments, when switching from the full-screen state back to the multi-channel casting window state, the display apparatus can also obtain a first resolution of the first casting screen and a second resolution of the second casting screen in response to a multi-window command for exiting the full-screen display of the first casting window; reset the first target display area according to the first resolution and reset the second target display area according to the second resolution; and control the display to display the first casting screen in the reset first target display area and the second casting screen in the reset second target display area.

Since the multi-channel casting interface includes the first casting window and the second casting window, the display apparatus needs to reset the first target display area and the second target display area when switching back to the multi-channel casting interface. The method of resetting the first target display area and the second target display area can be the same as the multi-window display method provided in the above embodiments, that is, obtaining the first resolution of the first casting screen and the second resolution of the second casting screen, and then resetting the first target display area according to the first resolution and resetting the second target display area according to the second resolution.

For example, when the display apparatus is displaying the first casting screen in the full screen, the user inputs a multi-window command by pressing the “back” key on the remote control to control the display apparatus to exit the full-screen state and switch back to the multi-channel casting interface. In response to the multi-window command, the display apparatus can obtain the resolutions of the casting screens of the first terminal device 510 and the second terminal device 520 respectively, that is, for two landscape casting screens, the resolutions of both the first and second casting screens are 1920×1080. In this case, the display apparatus can reset two display areas with a size of 954×538 according to the resolutions of the first and second casting screens, and the reset data content of the display areas is as follows.

For the first casting window: FrameLayout.LayoutParams lp1=new FrameLayout. LayoutParams(width, height, 0); lp1.width=954; lp1.height=538; lp1.leftMargin=0; lp1.topMargin=271; mPlayerView.setLayoutParams(lp1).

For the second casting window: FrameLayout.LayoutParams lp1=new FrameLayout. LayoutParams(width, height, 0); lp1.width=954; lp1.height=538; lp1.leftMargin=966; lp1.topMargin=271; mPlayerView.setLayoutParams(lp1).

In this way, when switching back to the multi-channel casting interface, the display apparatus can directly complete the switch by resetting the first target display area and the second target display area. In the multi-channel casting interface that has been switched back, the second casting window directly displays the casting screen without the need to re-establish the casting connection with the second terminal device 520 or display a guide page, thereby improving the interface switching speed.

To improve the interface switching speed, the display apparatus can also record the display size of each casting window in the multi-channel casting interface. That is, the display apparatus can set the sizes of the first casting window and the second casting window, i.e., a first window size and a second window size, according to the screen resolution and the image sizes of the first and second casting screens in response to a casting command for displaying the multi-channel casting interface; and then record the first window size and the second window size.

The display apparatus can dynamically set the first window size and the second window size according to the image sizes of the casting screens in the manner provided in the above embodiments to improve the space utilization of the display area. That is, the display apparatus can obtain a first aspect ratio of the first casting screen and a second aspect ratio of the second casting screen; based on that the first aspect ratio is not equal to the second aspect ratio, set the first window size of the first casting window according to the first aspect ratio and set the second window size of the second casting window according to the second aspect ratio; control the display to display the first casting window according to the first window size and the second casting window according to the second window size; and record the first window size and the second window size.

When setting the first window size and the second window size, the display apparatus can perform aligned display of the first casting window and the second casting window in the manner provided in the above embodiments. That is, window heights of the first window size and the second window size are equal, or window widths of the first window size and the second window size are equal.

After recording the first window size and the second window size, when resetting the first target display area according to the first resolution and resetting the second target display area according to the second resolution, the display apparatus can directly obtain the first window size and the second window size, and set the first target display area according to the first window size and set the second target display area according to the second window size. Herein, the first window size is a window size of the first casting window recorded by the display apparatus when displaying the multi-channel casting interface; and the second window size is a window size of the second casting window recorded by the display apparatus when displaying the multi-channel casting interface.

In some embodiments, after setting the conversion mode parameters for the casting windows, the display apparatus can synchronously modify the conversion mode parameters after switching back to the multi-channel casting interface. That is, the display apparatus can set the conversion mode parameters of the first casting window and the second casting window to a third parameter value in response to a multi-window command for exiting the full-screen display of the first casting window, herein, the third parameter value represents multi-window display of the casting windows.

For example, after switching back to the multi-channel casting interface, the display apparatus can modify the SwitchMode parameter of the first casting window from the first parameter value full to the third parameter value double, and at the same time, modify the SwitchMode parameter of the second casting window from the second parameter value Hidden to the third parameter value double, to indicate various logics and display processes during switching.

In some embodiments, after switching to the full-screen state, the display apparatus can also record a full-screen display duration of the first casting screen and determine the full-screen display duration. Based on that the full-screen display duration is greater than or equal to a preset duration threshold, that is, the user has been watching the first casting screen in the full screen for a long time, the probability of switching back to the multi-channel casting interface is low. To save the computing resources of the display apparatus, the casting connection channel with the second terminal device 520 can be closed, thereby controlling the display to stop displaying the second casting screen in the second target display area.

For example, after the user clicks the fullscreen button control below the first casting window to control the display apparatus to display the first casting screen in the full screen, the display apparatus can record the full-screen display duration of the first casting screen. When the full-screen display duration exceeds 30 minutes, the casting connection channel with the second terminal device 520 can be directly closed, so that the display apparatus only displays the first casting screen, reducing the resource occupation caused by the processing of the second casting screen.

In some embodiments, after setting the first target display area of the first casting window according to the screen resolution, the display apparatus can also detect display content of the second casting window; based on that the display content of the second casting window is a guide image, close the second casting window; based on that the display content of the second casting window is a casting screen, set the second target display area of the second casting window.

The display apparatus switches modes when there is only one Client, i.e., one casting screen and one guide page, as shown in the aforementioned FIG. 25. In this case, the display apparatus is in the dual-channel casting mode. After the user selects the RecycleView control for playback control operations on the first terminal device side, the first target display area needs to be displayed in the full screen. The View management module needs to synchronize the user's operation to the mode management module, and the mode management module modifies the SwitchMode parameter from double to full and synchronizes it to the data management module for data update. The data update process is to switch the data of the first target display area from Session: SessionClient1,View: SurfaceView/TextureView, MViewPosition:1,Position: (0,272), Width:954,Height:537,SwitchMode:double . . . to the following form: Session: SessionClient1,View: SurfaceView/TextureView, MViewPosition:1,Position: (0,0), Width:1920,Height:1080,SwitchMode:full . .

In this case, the right casting window displays a guide page instead of a target display area, so there is no need for minimal-pixel display processing, and no playback is involved. The View of the right Guide can be directly set to INVISIBLE. That is, after receiving the data information, the View management module sets the display parameter through LayoutParams. The display parameter may include the position relative to the top boundary and left boundary, i.e., coordinates, as well as the corresponding display width and height.

Based on this, the position of the first target display area can be displayed through the setLayoutParams method, that is: FrameLayout.LayoutParams lp1=new FrameLayout.LayoutParams(width, height, 0); lp1.width=1920; lp1.height=1080; lp1.leftMargin=0; lp1.topMargin=0; mPlayerView.setLayoutParams(lp1). Then, the Layout of the right guide page can have its View set to the INVISIBLE state through the setVisibility method of the View, as shown in FIG. 34.

Similarly, to switch from the full-screen display of the first casting screen back to the multi-channel casting interface, a specific interaction method can also be used, such as a menu key or any other interaction (e.g., voice) to trigger the window switching. For example, a default size of the guide page is 954×538, i.e., Guide: 954×538; and a display size of the first target display area is 1920×1080, i.e., Client 1: 1920×1080.

According to the algorithm provided in the above embodiments, the current video and the guide page can be displayed in a 1:1 landscape ratio, the full-screen mode data is switched to two-window data, and the SwitchMode parameter is synchronously modified from full to double. After receiving the data information, the View management module sets the display parameter through LayoutParams. The display parameter includes the position relative to the top boundary and left boundary, i.e., coordinates, as well as the corresponding display width and height.

After setting the display parameter, the position of the first target display area can be displayed through the setLayoutParams method, that is: FrameLayout.LayoutParams lp1=new FrameLayout.LayoutParams(width, height, 0); lp1.width=1920; lp1.height=1080; lp1.leftMargin=0; lp1.topMargin=0; mPlayerView.setLayoutParams(lp1). Then, the Layout of the right guide page can have its View set to the VISIBLE state through the setVisibility method of the View.

In addition, considering that in the audio transmission process of multi-channel screen casting, if the audio playback of multi-channel screen casting is not controlled, the audio of multi-channel screen casting will be played at the same time, resulting in sound conflicts and thus degrading user experience.

Based on this, the display apparatus of the embodiments of the present disclosure can also maintain a global casting list (SessionList) for managing the access and removal operations of Sessions. That is, the casting list is configured to record the terminal devices 500 that have established casting connections with the display apparatus and a connection order of the terminal devices 500 establishing casting connections with the display apparatus. The display apparatus can adjust an audio mode of multi-channel screen casting through the casting list, set the audio mode of one terminal device 500 in the casting list to a non-mute mode, and set other terminal devices 500 to a mute mode, so that the display apparatus only plays the audio of one screen casting channel.

When setting the audio mode, an audio management module of the display apparatus may set an audio parameter. When the audio mode is the non-mute mode, the audio parameter may be a first audio parameter, which is configured to indicate that audio data is allowed to be played; when the audio mode is the mute mode, the audio parameter may be a second audio parameter, which is configured to indicate that audio data is not allowed to be played, to indicate various logics and display processes during audio mode switching.

Setting the audio mode of one terminal device 500 in the casting list to the mute mode can be achieved in various ways. After the display apparatus establishes a casting connection with the terminal device 500, when obtaining the casting screen data including video data and audio data, the display apparatus may filter out the audio data and only receive the video data to realize audio muting of this screen casting channel. The display apparatus can also receive video data and audio data but not play the audio data through an audio output interface 270, to realize audio muting of this screen casting channel. Based on the casting protocol, the display apparatus can also make the terminal device 500 that has established a casting connection with it not send audio data, to realize audio muting of this screen casting channel. For example, in some casting protocols, it can be set to only transmit video data, so that the terminal device 500 only sends video data without sending audio data.

In some embodiments, the display apparatus can set the audio mode of one screen casting channel that first establishes the casting connection to the non-mute mode, i.e., the terminal device 500 (Client) that preempts the audio playback right first obtains the audio playback right. Alternatively, the display apparatus can set the audio mode of one screen casting channel that last establishes the casting connection to the non-mute mode, i.e., the terminal device 500 (Client) that establishes the latest casting connection obtains the audio playback right.

Through the above process, the display apparatus provided in the embodiments of the present disclosure can record, based on the casting list, the terminal devices that have established casting connections with the display apparatus and the connection order of the terminal devices establishing casting connections with the display apparatus. When the display apparatus establishes casting connections with at least two terminal devices, the display apparatus adjusts the audio mode of multi-channel screen casting via the casting list, sets the audio mode of one terminal device in the casting list to the non-mute mode, and sets the audio mode of other terminal devices to the mute mode, so that the display apparatus only plays audio from one screen casting channel. This allows dynamic setting of audio according to different casting scenarios and user-initiated dynamic audio control, resolving the problem of sound conflicts during multi-channel screen casting.

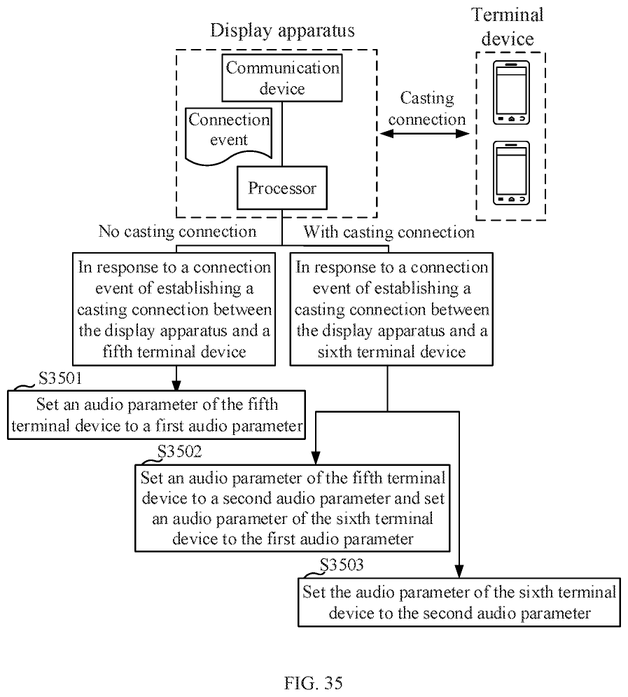

FIG. 35 is a flow diagram of audio playback control according to some embodiments. As shown in FIG. 35, when no casting connection is established, the display apparatus may, in response to a connection event of establishing a casting connection between the display apparatus and a fifth terminal device, execute step S3501 of setting an audio parameter of the fifth terminal device to a first audio parameter. When a casting connection has been established, the display apparatus may, in response to a connection event of establishing a casting connection between the display apparatus and a sixth terminal device, execute step S3502 of setting an audio parameter of the fifth terminal device to a second audio parameter and setting an audio parameter of the sixth terminal device to the first audio parameter, or execute step S3503 of setting the audio parameter of the sixth terminal device to the second audio parameter. Herein, the fifth terminal device is a terminal device 500 whose current audio parameter is the first audio parameter.

For example, when the UsessionConnectionListener detects a Session connection (i.e., connection with the fifth terminal device Client5), Client5 is added to the SessionList, and the audio mode of Client5 is set to the non-mute mode via the setAudioOutputState method of the Session, meaning the first casting session outputs audio. In this case, if the UsessionConnectionListener detects another Session connection (i.e., connection with the sixth terminal device Client6), Client6 is added to the SessionList. Since the first casting session is already outputting audio, simultaneous audio output from both sessions would result in audio confusion, so after the second session is connected, the audio mode of Client6 is set to the mute mode via the setAudioOutputState method of the Session, meaning the second casting session does not output audio.

To help users distinguish between the audio-active casting terminal and the muted casting terminal, the display apparatus can create an audio view in response to a connection event that establishes a casting connection between the display apparatus and the terminal device 500, herein the audio view is a control for performing playback control on audio data in the casting interface. The audio view includes a first icon and a second icon, the first icon is configured to indicate the non-mute mode and the second icon is configured to indicate the mute mode. When the audio mode of the terminal device 500 in the casting list is the non-mute mode, the display apparatus controls the display to display the first icon of the audio view. When the audio mode of the terminal device 500 in the casting list is the mute mode, the display apparatus controls the display to display the second icon of the audio view. Therefore, the current audio mode of screen casting is intuitively presented to the user through the icon of the audio view.

To facilitate switching of icons of the audio view, an association relationship between a status identifier of the audio view and the audio parameter of the terminal device 500 may be established. That is, the display apparatus can read the audio parameter of the terminal device 500 in the casting list; based on that the audio parameter is the first audio parameter, set the status identifier of the audio view to a first identifier value; based on that the audio parameter is the second audio parameter, set the status identifier of the audio view to a second identifier value.

When displaying the audio view, the display apparatus can read the status identifier of the audio view; based on that the status identifier is the first identifier value, the display apparatus controls the display to display the first icon of the audio view; based on that the status identifier is the second identifier value, the display apparatus controls the display to display the second icon of the audio view.

For example, taking the above embodiment as an example, when the UsessionConnectionListener detects a Session connection, Client5 is added to the SessionList, and the audio mode of Client5 is set to the non-mute mode via the setAudioOutputState method of the Session, meaning the first casting session outputs audio. As shown in FIG. 36, the content of the first casting session is displayed through the left casting window; and based on the display area of the left casting window, playback control views including fullscreen, close, mute/non-mute, play/pause, fast forward and fast rewind are created and displayed. Herein, since the audio mode of screen casting corresponding to the left casting window is the non-mute mode, the status identifier of the audio view representing “mute/non-mute” in the playback control view is set to the first identifier value, i.e., mStatus=false, indicating the current mode is the non-mute mode. The playback control list data of Client5 is as follows:

DoublePushControlBean[mStatus=true, mType=fullscreen, mResId=2131231132], DoublePushControlBean[mStatus=true, mType=rewind, mResId=2131231110], DoublePushControlBean[mStatus=true, mType=playstatus, mResId=2131231149], DoublePushControlBean[mStatus=true, mType=forward, mResId=2131231111], DoublePushControlBean[mStatus=false, mType=mutestatus, mResId=2131231152], DoublePushControlBean[mStatus=true, mType=close, mResId=2131231121].

In this case, if the UsessionConnectionListener detects another Session connection (i.e., connection with the sixth terminal device), Client6 is added to the SessionList. Since the first casting session is already outputting audio, simultaneous audio output from both sessions would result in audio confusion. So after the second session is connected, the audio mode of Client6 is set to the mute mode via the setAudioOutputState method of the Session, meaning the second casting session remains silent. As shown in FIG. 36, the content of the second casting session is displayed through the right casting window; and based on the display area of the right casting window, playback control views including fullscreen, close, mute/non-mute, play/pause, fast forward and fast rewind are created and displayed. Herein, since the audio mode of screen casting corresponding to the right casting window is the mute mode, the status identifier of the audio view representing “mute/non-mute” in the playback control view is set to the second identifier value, i.e., mStatus=true, indicating the current mode is the mute mode. The playback control list data of Client6 is as follows:

DoublePushControlBean[mStatus=true, mType=fullscreen, mResId=2131231132], DoublePushControlBean[mStatus=true, mType=rewind, mResId=2131231110], DoublePushControlBean[mStatus=true, mType=playstatus, mResId=2131231149], DoublePushControlBean[mStatus=true, mType=forward, mResId=2131231111], DoublePushControlBean[mStatus=true, mType=mutestatus, mResId=2131231152], DoublePushControlBean[mStatus=true, mType=close, mResId=2131231121].

Based on the playback control list data of Client5 and Client6 above, the icon display statuses of the mutestatus-type views in the RecycleViews of the left and right casting windows are set respectively, and the display of the playback control view is configured via the setBackgroundResource method, presenting the display effect as shown in FIG. 36. Herein, the audio view below the left casting window displays the first icon and the audio view below the right casting window displays the second icon.

After the display apparatus displays the audio view, the user can control the audio mode of screen casting corresponding to the relevant casting window based on the audio view. That is, the display apparatus can listen to the user's operation through the onClick event of the RecycleView, and perform mute/unmute processing on the selected Client according to the user's selection, while performing the reverse operation on the unselected Clients.

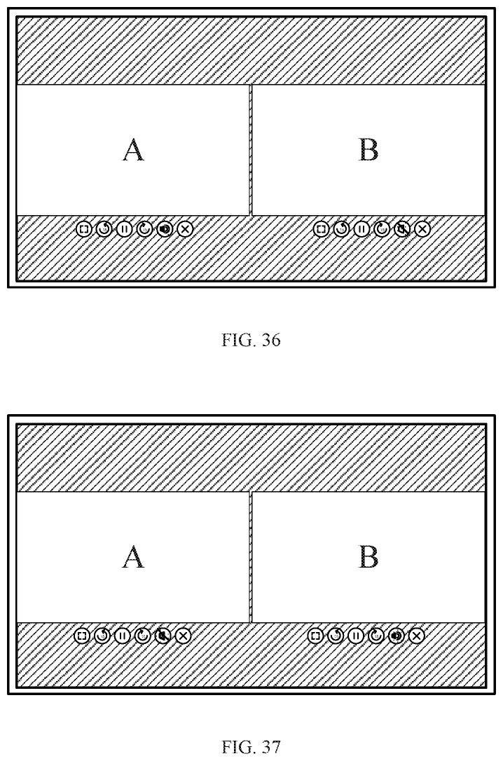

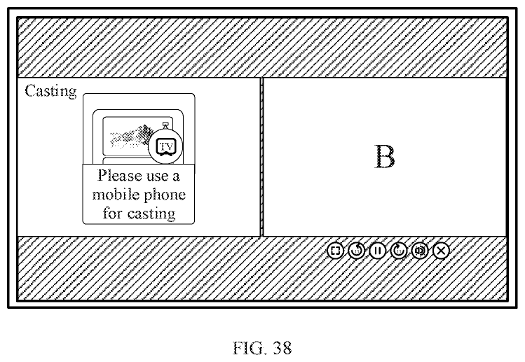

For example, for the audio view shown in FIG. 36, the user can use the direction keys on the remote control adapted to the display apparatus to move the focus cursor to the “mute/non-mute” playback function button below the left casting window, and press the “confirm” key on the remote control to input a mute command. In this case, the RecycleView may detect the user's onClick operation, set the audio mode of Client5 from the non-mute mode to the mute mode via the setAudioOutputState of the Session, and set the audio mode of Client6 from the mute mode to the non-mute mode. Simultaneously, the display of the playback control view is set via the setBackgroundResource method, presenting the display effect as shown in FIG. 37. Herein, the audio view below the left casting window displays the second icon and the audio view below the right casting window displays the first icon.

In some embodiments, when one screen casting channel with the non-mute mode in the casting list is disconnected, audio can be dynamically switched according to the casting list. That is, in response to an exit event for disconnecting the casting connection between the display apparatus and the fifth terminal device, the display apparatus can remove the fifth terminal device from the casting list, determine a seventh terminal device in the casting list according to the connection order, and set the audio parameter of the seventh terminal device to the first audio parameter. Herein, the fifth terminal device is a terminal device 500 whose current audio parameter is the first audio parameter in the casting list.

For example, taking the dual-channel screen casting shown in FIG. 36 as an example, Client5 in the first screen casting channel outputs audio. In this case, if Client5 is disconnected, Client5 is removed from the SessionList, leaving only Client6 in the SessionList. In this case, Client6 can be unmuted. First, the audio of the second screen casting channel is set to unmuted via the setAudioOutputState method of the Session in the casting management module, and this message is notified to the data management module via the message management module. The data management module updates the playback list data of Client6, and the updated data is as follows: DoublePushControlBean[mStatus=false, mType=mutestatus, mResId=2131231152].

After the data update is completed, the message is notified to the View management module via the message processing module, and the View management module performs dynamic refresh and display processing on the RecycleView, presenting the display effect as shown in FIG. 38.

The above implementation can achieve dynamic audio switching, but in some scenarios, users do not want to switch audio. For example, taking the dual-channel screen casting shown in FIG. 36 as an example, Client5 in the first screen casting channel is in the non-mute mode and Client6 in the second screen casting channel is in the mute mode. During the screen casting process, if the media asset type of Client5 in the first screen casting channel is a push type, it may switch the episode of a film or television drama. During the episode switching process, due to differences between different mobile terminals, a Session switching may occur, which is equivalent to the access of a new Client. In addition, some mobile terminals switch to the push type after enabling screen mirroring, which also triggers the access of a new Session and is equivalent to the access of a new Client.

In the above scenarios, according to the previous processing logic, after Client5 in the first screen casting channel is disconnected, the display apparatus may perform unmute processing on Client6 in the second screen casting channel to switch audio. When the UsessionConnectionListener detects a new Session connection, based on the principle that the screen casting channel that preempts the audio playback right first obtains the audio playback right, the display apparatus may set the newly accessed third screen casting channel (i.e., the seventh terminal device Client7) to the mute mode. In other words, according to the above processing logic, after a screen casting channel switches episodes or changes the media asset type, it may lead to a phenomenon where its audio mode switches from the non-mute mode to the mute mode. However, from the user's perspective, the user's intention is that after a screen casting channel switches episodes or changes the media asset type, it continues to play according to the previous audio mode, i.e., Client7 in the third screen casting channel retains the audio mode of Client5 in the first screen casting channel.

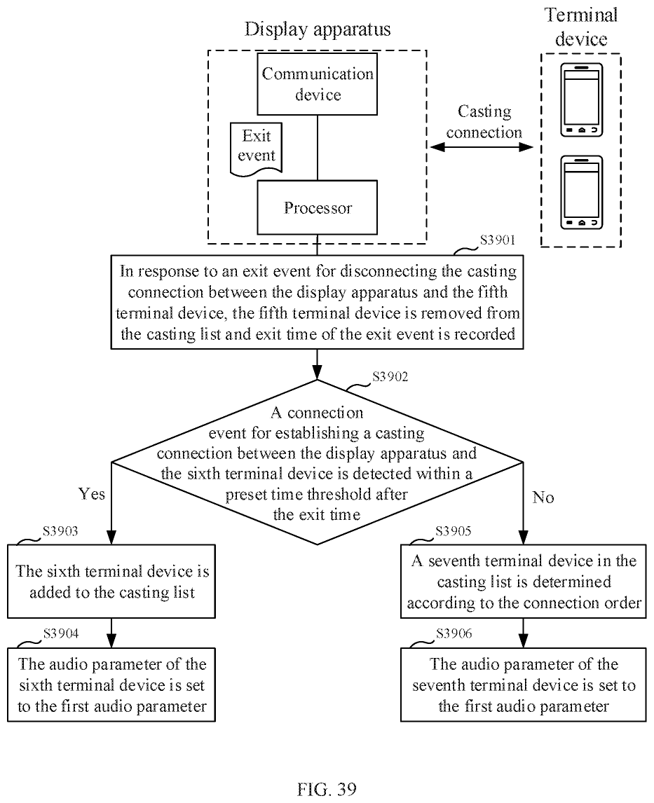

Therefore, the display apparatus can set a time threshold, audio switching is not performed within the time threshold following the occurrence of the exit event, and audio switching can only be performed after the time threshold following the occurrence of the exit event elapses. The implementation can be as shown in FIG. 39, including the following steps.

S3901: In response to an exit event for disconnecting the casting connection between the display apparatus and the fifth terminal device, the fifth terminal device is removed from the casting list and exit time of the exit event is recorded.

S3902: Whether a connection event for establishing a casting connection between the display apparatus and the sixth terminal device is detected within a preset time threshold after the exit time.

S3903: Based on that the connection event for establishing the casting connection between the display apparatus and the sixth terminal device is detected, the sixth terminal device is added to the casting list.

S3904: The audio parameter of the sixth terminal device is set to the first audio parameter.

In some embodiments, after setting the audio parameter of the sixth terminal device to the first audio parameter, if a connection event for establishing a casting connection between the display apparatus and an eighth terminal device is detected, the preset audio processing logic will continue to be applied. That is, in response to the connection event for establishing a casting connection between the display apparatus and the eighth terminal device, the display apparatus may set the audio parameter of the sixth terminal device to the second audio parameter and set the audio parameter of the eighth terminal device to the first audio parameter, or set the audio parameter of the eighth terminal device to the second audio parameter.

S3905: Based on that no connection event for establishing a casting connection between the display apparatus and the sixth terminal device is detected, a seventh terminal device in the casting list is determined according to the connection order.

S3906: The audio parameter of the seventh terminal device is set to the first audio parameter.

Determining the seventh terminal device in the casting list according to the connection order may be implemented in a variety of ways. In some embodiments, the display apparatus may select a terminal device 500 that first established a casting connection with the display apparatus in the casting list according to the connection order as the seventh terminal device, or select a terminal device that most recently established a casting connection with the display apparatus in the casting list according to the connection order as the seventh terminal device.

For the playback control list data, if the media asset type of the currently disconnected casting session is the same as the media asset type of the newly connected casting session within the time threshold, the playback control list data can be directly reused. That is, in response to an exit event for disconnecting the casting connection between the display apparatus and the fifth terminal device, the display apparatus can record a first media asset type of casting screen data of the fifth terminal device and the playback control list. Herein, the playback control list includes the playback control data of the playback control view associated with the first media asset type. Based on that a connection event for establishing a casting connection between the display apparatus and the sixth terminal device is detected within a preset time threshold after the exit time, the display apparatus obtains a second media asset type of casting screen data of the sixth terminal device. Based on that the first media asset type is the same as the second media asset type, the display apparatus sets the playback control list for the sixth terminal device.

For example, taking the dual-channel screen casting shown in FIG. 36 as an example, when the UsessionConnectionListener detects that Client5 is disconnected, Client5 is removed from the SessionList. After removal, a timer CountTimeUtils is started with a preset duration of 2s, and the audio switching method is locked within 2s, meaning no audio switching operation between the left and right casting windows is performed, that is, the setAudioOutputState method of the Session is invalid. If a new Client 7 is connected within 2s, Client 7 is added to the SessionList, and View layout is performed according to the VideoChanged event of Client7. Meanwhile, Client7 retains the audio mode originally adopted by Client5. If the media asset type of Client7 is the same as the media asset type of Client5, the playback control list data is reused. The playback control list data corresponding to Client7 is as follows:

DoublePushControlBean[mStatus=true, mType=fullscreen, mResId=2131231132], DoublePushControlBean[mStatus=true, mType=rewind, mResId=2131231110], DoublePushControlBean[mStatus=true, mType=playstatus, mResId=2131231149], DoublePushControlBean[mStatus=true, mType=forward, mResId=2131231111], DoublePushControlBean[mStatus=false, mType=mutestatus, mResId=2131231152], DoublePushControlBean[mStatus=true, mType=close, mResId=2131231121].

If the UsessionConnectionListener does not detect the connection of a new Client7 after the 2s timer expires, the audio for Client 6 in the SessionList is set. The audio mode of Client 6 is set to the non-mute mode via the setAudioOutputState method of the Session. Data is synchronized to the data management module for update, and synchronized to the View management module via the message processing module to refresh the display of the View.

To improve the display effect, in response to an exit event for disconnecting the casting connection between the display apparatus and the fifth terminal device, the display apparatus can also record a display position parameter of a target casting window. Herein, the target casting window is a casting window displaying the casting screen of the fifth terminal device. Based on that a connection event for establishing a casting connection between the display apparatus and the sixth terminal device is detected within a preset time threshold after the exit time, the display apparatus controls the display to display the casting screen of the sixth terminal device in the target casting window according to the display position parameter.

For example, as shown in FIG. 38, the media asset image of Client6 in the second casting session is displayed through the right casting window. When the UsessionConnectionListener detects that Client6 is disconnected, Client6 is removed from the SessionList, and the display position parameter of the right casting window is recorded. After removal, a timer CountTimeUtils is started with a preset duration of 2s. If a new Client 7 is connected within 2s, Client 7 is added to the SessionList, and the display position of Client7 is set according to the recorded display position parameter, so that the media asset image of Client7 is displayed through the right casting window.

In some embodiments, the display apparatus also supports audio mode locking for casting windows. Once the audio mode of a certain casting window is locked, the casting window can always maintain the audio mode prior to being locked, without performing audio switching. For this purpose, the casting management module of the display apparatus performs monitoring and management of the Session, and the audio management module sets the audio mode. After the user operates on the View, the View management module monitors the user's actions and then refreshes the View. Meanwhile, the message processing module notifies the data management module to update data. When the casting management module detects an exit event of the casting connection, it notifies the time management module to conduct time monitoring via the message processing module, to determine whether to perform audio switching. Meanwhile, the above operations are all dynamic audio switching performed when the mode management module notifies that the audio mode of the current casting window is not locked. If the audio mode of the current casting window is locked, the locked casting window will not perform audio switching, and the casting window on the other side always maintains the default audio mode for display without audio switching.

Therefore, in response to a lock command for a specified casting window, the display apparatus can record the current target audio parameter of the specified casting window and set a lock value for the specified casting window. Herein, the lock value indicates that a window state of the specified casting window is locked, indicating that the audio parameter of the terminal device whose casting screen is displayed in the specified casting window is set to the target audio parameter.

When the display apparatus receives a display command for displaying the casting screen of a target terminal device in the specified casting window, in response to the display command, the display apparatus can read a lock value of the specified casting window to detect a window state of the specified casting window. Based on that the window state is a locked state, the display apparatus obtains a target audio parameter of the specified casting window and sets the audio parameter of the target terminal device to the target audio parameter. Herein, the target audio parameter is an audio parameter, of the terminal device whose casting screen is displayed in the specified casting window, recorded when the window state is set to the locked state.

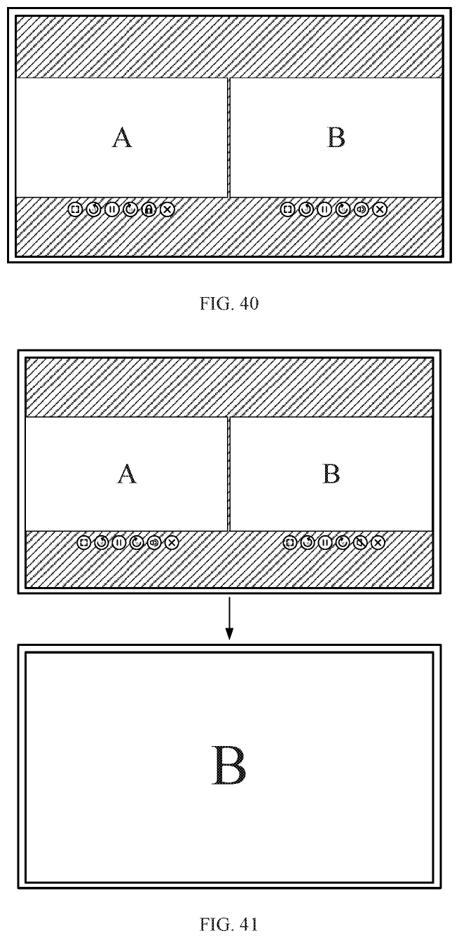

For example, taking the dual-channel screen casting shown in FIG. 37 as an example, Client5 in the first screen casting channel is in the mute mode and Client6 in the second screen casting channel is in the non-mute mode. In this case, the user long-presses the “sound” playback function control below the left casting window shown in FIG. 37 to input a lock command for the left casting window. In response to the lock command, the display apparatus can lock the current mute mode of the left casting window, and set mBlockStatus in the DoublePushControlBean of the current mutestatus type to true. That is, after the View management module detects the user's long-press action, it refreshes the View, presenting the display effect as shown in FIG. 40, where the audio view below the left casting window displays a third icon. Then, this operation is notified to the data management module via the message processing module, and the data management module sets mBlockStatus to true. After the setting is successful, the audio mode of the locked left casting window is memorized, i.e., mIsPlayControlVoiceBlocked=true and mIsPlayControlVoiceBlockedLeft=true are globally set. The playback control list data of Client5 is as follows:

DoublePushControlBean[mStatus=true, mType=fullscreen, mResId=2131231132], DoublePushControlBean[mStatus=true, mType=rewind, mResId=2131231110], DoublePushControlBean[mStatus=true, mType=playstatus, mResId=2131231149], DoublePushControlBean[mStatus=true, mType=forward, mResId=2131231111], DoublePushControlBean[mStatus=true, mType=mutestatus, mBlockStatus=true, mResId=213123115 2],

DoublePushControlBean[mStatus=true, mType=close, mResId=2131231121].

After the above operation, regardless of whether a new Client is added or an existing Client is disconnected, the audio mode of the left casting window will not change. If Client6 is disconnected, Client6 is removed from the SessionList. In this case, although only Client5 in the mute mode remains in the SessionList, no audio reset will be triggered because mIsPlayControlVoiceBlocked is set to true. Moreover, when the media asset image of a newly connected eighth terminal device Client8 is displayed in the left casting window, since mIsPlayControlVoiceBlocked and mIsPlayControlVoiceBlockedLeft are set to true, the audio mode of Client8 remains in the mute mode. The specific data is as follows:

DoublePushControlBean[mStatus=true, mType=fullscreen, mResId=2131231132]; DoublePushControlBean[mStatus=true, mType=rewind, mResId=2131231110]; DoublePushControlBean[mStatus=true, mType=playstatus, mResId=2131231149]; DoublePushControlBean[mStatus=true, mType=forward, mResId=2131231111], DoublePushControlBean[mStatus=true, mType=mutestatus, mBlockStatus=true, mResId=213123115 2]; Doublepushcontrolbean[mstatus=true, Mtype=close, Mresid=2131231121].

In some embodiments, when a casting window is switched from a small window to the full screen, the corresponding logical processing of audio is also required. In response to a full-screen command for displaying the specified casting window in the full screen, the display apparatus can delete other terminal devices except the target terminal device from the casting list and disconnect casting connections with other terminal devices. Herein, the target terminal device is the terminal device whose casting screen is displayed in the specified casting window. Then, the display apparatus reads the audio parameter of the target terminal device. Based on that the audio parameter is the second audio parameter, the display apparatus sets the audio parameter of the target terminal device to the first audio parameter and displays the specified casting window in the full screen. Based on that the audio parameter is the first audio parameter, the display apparatus displays the specified casting window in the full screen.

For example, taking the dual-channel screen casting shown in FIG. 36 as an example, Client5 in the first screen casting channel is in the non-mute mode and Client6 in the second screen casting channel is in the mute mode. In this case, as shown in FIG. 41, the user clicks the “fullscreen” playback function control below the right casting window shown in FIG. 36. First, Client5 is removed from the SessionList, and then the View corresponding to Client5 is removed from the ViewList of the display window. Then, the display window is reset, and the display area and position of Client6 are set according to the window size. Meanwhile, Client6 is unmuted via the setAudioOutputState method of the Session, presenting the display effect as shown in FIG. 41.

Through the above process, the display apparatus can perform dynamic audio configuration according to different casting scenarios, and can also perform dynamic audio control according to user's active selection, thereby resolving the problem of sound conflicts during multi-channel screen casting. It should be noted that the audio processing solutions are not limited to the above examples; and multiple casting windows and multiple casting protocols can also refer to the above rules. In addition, audio processing can not only include mute/non-mute operations, but also include volume adjustment, such as entering a secondary menu through the audio view or adding other display buttons to adjust the volume.

What is claimed is:

1. A display apparatus, comprising:
a display, configured to display a multi-channel casting interface; wherein the multi-channel casting interface comprises a first guide window and a second guide window; the first guide window and the second guide window each is configured to display a guide page; and the first guide window and the second guide window both share a same root node as the multi-channel casting interface;
a user input interface, configured to receive a command from a user;
a communication device, configured to establish a communication connection with a terminal device;
a memory, configured to store computer instructions and data associated with the display apparatus; and
at least one processor, connected to the display, the user input interface, the communication device and the memory; wherein the at least one processor is configured to execute the computer instructions to enable the display apparatus to:
in response to a casting connection command sent from a first terminal device, create a first casting window, release the first guide window, and retain displaying the second guide window in the multi-channel casting interface; wherein the first casting window is configured to display a first casting screen of the first terminal device, and the first casting window shares the same root node as the multi-channel casting interface;
obtain a first casting session sent from the first terminal device, wherein the first casting session comprises a first resolution of the first casting screen;
detect a screen resolution and a reference resolution of the guide page;
calculate a window display area according to the screen resolution, the first resolution, and the reference resolution; wherein the window display area comprises a first display area and a second display area; and a height of the first display area and a height of the second display area are equal; and
control the display to display the first casting window in the first display area and display the second guide window in the second display area.

2. The display apparatus according to claim 1, wherein the at least one processor is further configured to execute the computer instructions to enable the display apparatus to:
in response to a casting connection command sent from a second terminal device, create a second casting window and release the second guide window; wherein the second casting window is configured to display a second casting screen of the second terminal device; and the second casting window shares the same root node as the multi-channel casting interface;
obtain a second casting session sent from the second terminal device, wherein the second casting session comprises a second resolution of the second casting screen;
detect the screen resolution and the first resolution;
calculate a window display area according to the screen resolution, the first resolution, and the second resolution; wherein the window display area comprises a third display area and a fourth display area; and a height of the third display area and a height of the fourth display area are equal;
control the display to display the first casting window in the third display area and display the second casting window in the fourth display area;
wherein the at least one processor is further configured to execute the computer instructions to enable the display apparatus to:
in response to a casting termination command for the first casting session, remove the first casting window and call the first guide window;
detect the screen resolution and the second resolution;
calculate a window display area according to the screen resolution, the second resolution, and the reference resolution; wherein the window display area comprises a fifth display area and a sixth display area; and a height of the fifth display area and a height of the sixth display area are equal;
control the display to display the first guide window in the fifth display area and display the second casting window in the sixth display area.

3. The display apparatus according to claim 1, wherein the at least one processor is configured to execute the computer instructions to enable the display apparatus to:
read a horizontal pixel value and a vertical pixel value of the screen resolution;
calculate a first aspect ratio according to a ratio of a horizontal pixel value to a vertical pixel value in the first resolution, and calculate a second aspect ratio according to a ratio of a horizontal pixel value to a vertical pixel value in the reference resolution;
set a first layout parameter and a second layout parameter; wherein the first layout parameter comprises a first layout width and a first layout height, and the second layout parameter comprises a second layout width and a second layout height; the first layout height is equal to the second layout height, a sum of the first layout width and the second layout width is equal to the horizontal pixel value of the screen resolution, the first layout height and the second layout height are both less than or equal to the vertical pixel value of the screen resolution, a ratio of the first layout width to the first layout height is equal to the first aspect ratio, and a ratio of the second layout width to the second layout height is equal to the second aspect ratio;
generate the first display area according to the first layout parameter and generating the second display area according to the second layout parameter.

4. The display apparatus according to claim 3, wherein the at least one processor is configured to execute the computer instructions to enable the display apparatus to:
generate layout position coordinates of the first casting window according to the first layout parameter;
record the first layout parameter and the layout position coordinates;
drawi the first casting window according to the first layout parameter and the layout position coordinates;
and/or,
wherein the at least one processor is further configured to execute the computer instructions to enable the display apparatus to:
after controlling the display to display the first casting window, calculate a window aspect ratio of the first casting window according to the first layout width and the first layout height;
compare the window aspect ratio with the first aspect ratio;
based on that the window aspect ratio is not equal to the first aspect ratio, scale the first casting screen in the first casting window.

5. The display apparatus according to claim 3, wherein the at least one processor is further configured to execute the computer instructions to enable the display apparatus to:
read a first preset height of an edge area; wherein the edge area comprises a display area in the multi-channel casting interface except the first casting window and the second guide window;
set a sum of the first layout height and the first preset height to be equal to the vertical pixel value of the screen resolution, and generate the first layout height based on the first preset height;
wherein the at least one processor is further configured to execute the computer instructions to enable the display apparatus to:
after controlling the display to display the first casting window, in response to a focus event of the first casting window, control the display to display a playback function control in the edge area;
read a second preset height of the edge area; wherein the second preset height is greater than the first preset height;
set a sum of the first layout height and the second preset height to be equal to the vertical pixel value of the screen resolution, and generate the first layout height based on the second preset height.

6. The display apparatus according to claim 1, wherein the at least one processor is further configured to execute the computer instructions to enable the display apparatus to:
monitor a change event of the first casting session;
in response to detecting a change event of the first resolution, detect a changed resolution of the first casting screen; wherein the changed resolution is a resolution of the first casting screen after the change event of the first resolution is executed;
calculate a window display area according to the screen resolution, the changed resolution, and the reference resolution; wherein the window display area comprises a seventh display area and an eighth display area; and a height of the seventh display area and a height of the eighth display area are equal;
control the display to display the first casting window in the seventh display area and display the second guide window in the eighth display area.

7. The display apparatus according to claim 1, wherein the at least one processor is further configured to execute the computer instructions to enable the display apparatus to:
in response to a casting connection command sent from a third terminal device, detect a casting replacement mode;
based on that the casting replacement mode is a first mode, detect a focus position of a focus frame, remove a first replacement casting window at the focus position, and display a third casting window according to an orientation identifier of the first replacement casting window; wherein the orientation identifier represents a display orientation of the first replacement casting window, the third casting window is configured to display a third casting screen of the third terminal device, and the third casting window shares the same root node as the multi-channel casting interface;
based on that the casting replacement mode is a second mode, detect lock attributes of casting windows, remove a second replacement casting window according to the lock attributes, and display the third casting window according to an orientation identifier of the second replacement casting window; wherein the second replacement casting window is a casting window whose lock attribute is in an unlocked state;
wherein the at least one processor is further configured to execute the computer instructions to enable the display apparatus to:
obtain the lock attributes of the casting windows;
based on that the lock attributes of the casting windows are all in the unlocked state, set a replacement mode parameter to a first parameter; wherein the first parameter is configured to represent that the casting replacement mode is the first mode;
based on that the lock attributes of the casting windows comprise a locked state, set the replacement mode parameter to a second parameter; wherein the second parameter is configured to represent that the casting replacement mode is the second mode.

8. The display apparatus according to claim 7, wherein the at least one processor is configured to execute the computer instructions to enable the display apparatus to:
record a first orientation identifier of the first replacement casting window and creating the third casting window;
set an orientation identifier of the third casting window to the first orientation identifier;
draw the third casting window according to the first orientation identifier;
or,
wherein the at least one processor is further configured to execute the computer instructions to enable the display apparatus to:
based on that the casting replacement mode is the second mode, traverse the lock attributes of the casting windows;
based on that the lock attributes of the casting windows do not comprise the unlocked state, control the communication device to send a casting failure notification to the third terminal device;
wherein the at least one processor is configured to execute the computer instructions to enable the display apparatus to:
record a second orientation identifier of the second replacement casting window and creating the third casting window;
set an orientation identifier of the third casting window to the second orientation identifier;
draw the third casting window according to the second orientation identifier;
and/or,
wherein the at least one processor is further configured to execute the computer instructions to enable the display apparatus to:
control the display to display a target lock control; wherein the target lock control is associated with the third casting window;
in response to a selection command input from the user through the target lock control, refresh a current value of the lock control and a lock attribute of the third casting window.

9. The display apparatus according to claim 7, wherein the at least one processor is further configured to execute the computer instructions to enable the display apparatus to:
in response to a casting termination command for a target casting session, delete the target casting session; wherein the target casting session is a communication session generated based on the third terminal device;
record a third orientation identifier of the third casting window, remove the third casting window, and call a guide window; wherein the guide window is configured to display the guide page;
and the guide window shares the same root node as the multi-channel casting interface;
control the display to display the guide window according to the third orientation identifier;
wherein the at least one processor is further configured to execute the computer instructions to enable the display apparatus to:
detect the screen resolution, the reference resolution, and a casting screen resolution; wherein the reference resolution is a resolution of the guide page; and the casting screen resolution is a resolution of a casting screen in the multi-channel casting interface;
calculate a window layout parameter of the guide window according to the screen resolution, the reference resolution, and the casting screen resolution; wherein the window layout parameter comprises a layout width and a layout height;
wherein the at least one processor is configured to execute the computer instructions to enable the display apparatus to:
generate layout position coordinates of the guide window according to the window layout parameter and the third orientation identifier;
record the window layout parameter and the layout position coordinates;
draw the guide window according to the window layout parameter and the layout position coordinates.

10. The display apparatus according to claim 1, wherein the at least one processor is further configured to execute the computer instructions to enable the display apparatus to:
in response to a connection event for establishing a casting connection between the display apparatus and a fourth terminal device, obtain a media asset type of casting screen data;
extract playback control data associated with the media asset type from a playback control list, and create a playback control view according to the playback control data; wherein the playback control list comprises playback control data preset for playback control views, and the playback control view is a control in the multi-channel casting interface for performing playback control on the casting screen data;
set a display position of the playback control view according to a display area of a casting window corresponding to the fourth terminal device, and control the display to display the playback control view at the display position.

11. The display apparatus according to claim 10, wherein the at least one processor is further configured to execute the computer instructions to enable the display apparatus to:
obtain configuration information when the display apparatus establishes the casting connection with the fourth terminal device;
read the media asset type of the casting screen data of the fourth terminal device from the configuration information;
wherein the at least one processor is configured to execute the computer instructions to enable the display apparatus to:
call the playback control list; wherein the playback control data in the playback control list comprises status identifiers, playback control types, and resource identifiers; the status identifier represents a functional status of the playback control view; the playback control type represents a processing operation associated with the playback control view; and the resource identifier represents a functional module associated with the playback control view;
generate a playback control sublist according to the playback control data associated with the media asset type in the playback control list;
create the playback control view according to the playback control sublist;
wherein the at least one processor is configured to execute the computer instructions to enable the display apparatus to:
copy the playback control list and deleting playback control data not associated with the media asset type from the playback control list to generate the playback control sublist; or
create the playback control sublist and adding the playback control data associated with the media asset type in the playback control list to the playback control sublist.

12. The display apparatus according to claim 10, wherein the at least one processor is further configured to execute the computer instructions to enable the display apparatus to:
obtain an area size of the display area of the casting window corresponding to the fourth terminal device and a preset view size of the playback control view;
calculate a display quantity of the playback control views according to the area size and the view size;
extract the playback control data associated with the media asset type from the playback control list according to the display quantity.

13. The display apparatus according to claim 12, wherein the at least one processor is further configured to execute the computer instructions to enable the display apparatus to:
in response to a change notification of the display area, obtain a changed display area;
reset the display position of the playback control view according to the changed display area, and recalculate the display quantity of the playback control views according to an area size of the changed display area;
and/or,
wherein the at least one processor is configured to execute the computer instructions to enable the display apparatus to:
traverse weight values of the playback control data in the playback control list;
sort the playback control data in the playback control list in a descending order of the weight values;
extract first k pieces of playback control data associated with the media asset type from the sorted playback control list; wherein k is the display quantity, and k is greater than or equal to 0;
or,
wherein the at least one processor is further configured to execute the computer instructions to enable the display apparatus to:
obtain an area width of the display area and a total width of a playback control bar; wherein the playback control bar is obtained by arranging the playback control views associated with the media asset type according to a preset spacing;
based on that the area width is greater than or equal to the total width, extract the playback control data associated with the media asset type from the playback control list;
based on that the area width is less than the total width, calculate the display quantity according to the area width and the total width, and extract the playback control data associated with the media asset type from the playback control list according to the display quantity.

14. The display apparatus according to claim 1, wherein the at least one processor is further configured to execute the computer instructions to enable the display apparatus to:
in response to a click command for a target playback control view, obtain a playback control type of the target playback control view from a playback control list;
invoke a processing interface associated with the playback control type;
perform a processing operation associated with the target playback control view on casting screen data based on the processing interface.

15. The display apparatus according to claim 1, wherein the at least one processor is further configured to execute the computer instructions to enable the display apparatus to:
control an audio output interface to play audio data of a terminal device whose audio parameter is a first audio parameter in a casting list; wherein the audio parameter indicates whether audio data playback is permitted or prohibited, the first audio parameter indicates audio data playback is permitted, and the casting list is configured to record terminal devices that establish casting connections with the display apparatus and a connection order of the terminal devices establishing casting connections with the display apparatus;
in response to an exit event for disconnecting a casting connection between the display apparatus and a fifth terminal device, remove the fifth terminal device from the casting list and record an exit time of the exit event; wherein the fifth terminal device is a terminal device whose current audio parameter is the first audio parameter in the casting list;
based on that a connection event for establishing a casting connection between the display apparatus and a sixth terminal device is detected within a preset time threshold after the exit time, add the sixth terminal device to the casting list and set an audio parameter of the sixth terminal device to the first audio parameter;
based on that no connection event for establishing the casting connection between the display apparatus and the sixth terminal device is detected within the preset time threshold after the exit time, determine a seventh terminal device in the casting list according to the connection order and set an audio parameter of the seventh terminal device to the first audio parameter.

16. The display apparatus according to claim 15, wherein the at least one processor is configured to execute the computer instructions to enable the display apparatus to:
select, as the seventh terminal device, a terminal device that first established a casting connection with the display apparatus in the casting list according to the connection order; or
select, as the seventh terminal device, a terminal device that most recently established a casting connection with the display apparatus in the casting list according to the connection order;
or,
wherein the at least one processor is further configured to execute the computer instructions to enable the display apparatus to:
in response to a connection event for establishing a casting connection between the display apparatus and an eighth terminal device:
set the audio parameter of the sixth terminal device to a second audio parameter and set an audio parameter of the eighth terminal device to the first audio parameter; wherein the second audio parameter indicates audio data playback is prohibited; or
set an audio parameter of the eighth terminal device to the second audio parameter;
or,
wherein the at least one processor is further configured to execute the computer instructions to enable the display apparatus to:
in response to a full-screen command for displaying a specified casting window in a full screen, delete other terminal devices except a target terminal device from the casting list and disconnect casting connections with the other terminal devices; wherein the target terminal device is a terminal device whose casting screen is displayed in the specified casting window;
read an audio parameter of the target terminal device;
based on that the audio parameter is a second audio parameter, set the audio parameter of the target terminal device to the first audio parameter and display the specified casting window in the full screen;
based on that the audio parameter is the first audio parameter, display the specified casting window in the full screen.

17. The display apparatus according to claim 15, wherein the at least one processor is further configured to execute the computer instructions to enable the display apparatus to:
in response to a connection event for establishing a casting connection between the display apparatus and a terminal device, create an audio view; wherein the audio view is a control in the multi-channel casting interface for performing playback control on audio data;
read a status identifier of the audio view; wherein the status identifier has an association relationship with an audio parameter of the terminal device;
based on that the status identifier is a first identifier value, control the display to display a first icon of the audio view; wherein the first icon represents a non-mute mode;
based on that the status identifier is a second identifier value, control the display to display a second icon of the audio view; wherein the second icon represents a mute mode;
wherein the at least one processor is further configured to execute the computer instructions to enable the display apparatus to:
read the audio parameter of the terminal device;
based on that the audio parameter is the first audio parameter, set the status identifier of the audio view to the first identifier value;
based on that the audio parameter is the second audio parameter, set the status identifier of the audio view to the second identifier value.

18. The display apparatus according to claim 15, wherein the at least one processor is further configured to execute the computer instructions to enable the display apparatus to:
in response to a display command for displaying a casting screen of a target terminal device in a specified casting window, detect a window state of the specified casting window;
based on that the window state is a locked state, obtain a target audio parameter of the specified casting window; wherein the target audio parameter is an audio parameter, of a terminal device whose casting screen is displayed in the specified casting window, recorded when the window state is set to the locked state;
set an audio parameter of the target terminal device to the target audio parameter.

19. The display apparatus according to claim 15, wherein the at least one processor is further configured to execute the computer instructions to enable the display apparatus to:
in response to the exit event for disconnecting the casting connection between the display apparatus and the fifth terminal device, record a first media asset type of casting screen data of the fifth terminal device and a playback control list; wherein the playback control list comprises playback control data of a playback control view associated with the first media asset type, and the playback control view is a control in the multi-channel casting interface for performing playback control on the casting screen data;
based on that the connection event for establishing the casting connection between the display apparatus and the sixth terminal device is detected within the preset time threshold after the exit time, obtain a second media asset type of casting screen data of the sixth terminal device;
based on that the first media asset type is the same as the second media asset type, set the playback control list for the sixth terminal device;
or,
wherein the at least one processor is further configured to execute the computer instructions to enable the display apparatus to:
in response to the exit event for disconnecting the casting connection between the display apparatus and the fifth terminal device, record a display position parameter of a target casting window; wherein the target casting window is a casting window displaying a casting screen of the fifth terminal device;
based on that the connection event for establishing the casting connection between the display apparatus and the sixth terminal device is detected within the preset time threshold after the exit time, control the display to display a casting screen of the sixth terminal device in the target casting window according to the display position parameter.

20. A multi-channel casting control method, applied to the display apparatus according to claim 1, comprising:
in response to the casting connection command sent from the first terminal device, creating the first casting window, releasing the first guide window, and retaining displaying the second guide window in the multi-channel casting interface; wherein the first casting window is configured to display the first casting screen of the first terminal device, and the first casting window shares the same root node as the multi-channel casting interface; the multi-channel casting interface comprises the first guide window and the second guide window, and the first guide window and the second guide window each is configured to display the guide page; the first guide window and the second guide window both share the same root node as the multi-channel casting interface;
obtaining the first casting session sent from the first terminal device; wherein the first casting session comprises the first resolution of the first casting screen;
detecting the screen resolution and the reference resolution of the guide page;
calculating the window display area according to the screen resolution, the first resolution, and the reference resolution; wherein the window display area comprises the first display area and the second display area, and the height of the first display area and the height of the second display area are equal;
controlling the display to display the first casting window in the first display area and display the second guide window in the second display area.
